(19) United States
(12) Patent Application Publication
(10) Pub. No.: US 2019/0125623 A1
(43) Pub. Date: May 2, 2019

(54) Multi-Tool Massage Device

(71) Applicant: IQBody LLC, Coronado, CA (US)

(72) Inventor: Ryan J Spratt, Coronado, CA (US)

(73) Assignee: IQBody LLC, Coronado, CA (US)

(21) Appl. No.: 15/799,858

(22) Filed: Oct. 31, 2017

(51) Int. Cl. A61H 15/00; A61H 7/00

(52) U.S. Cl. CPC A61H 15/0092; A61H 7/007; A61H 2201/1695; A61H 2201/0107; A61H 2201/1253; A61H 2201/1635

(57) ABSTRACT

A combination multi-tool massage device in which one or more individual massage tools are assembled into a main spherical body, wherein the spherical body is itself a separate massage tool, is disclosed. A method of using one or more tools of the multi-tool massage device for massage treatment.is also disclosed.

### FIELD OF THE INVENTION

This invention generally relates to a combination multi-tool massage device in which one or more individual massage tools are assembled into a main spherical body, wherein the spherical body is itself a separate massage tool. The spherical body of the device is composed of a first hemispherical half and a second hemispherical half that engage and disengage one another, wherein the spherical body is configured to include one or more individual and distinct massage tools held in a fixed position inside the spherical body when the first hemispherical half and the second hemispherical are engaged. In addition, each hemispherical half can be used as a separate and distinct massage tool. The invention also relates to a method of using one or more tools of the multi-tool massage device for massage treatment.

### BACKGROUND OF THE INVENTION

Myofascial refers to muscle tissue (myo) and the connective tissue in and around it (fascia). Myofascial pain often results from muscle injury or repetitive strain. When stressed or injured, muscles often form trigger points, like contracted knots, that cause pain and tightness.

Myofascial trigger points are an extremely common cause of pain. Trigger points are painful when pressed on, cause a shortening of the muscle fibers, and exhibit a special property called referred pain, a trigger point in one muscle that creates pain in another area. For instance, when the muscle at the top of a human shoulder (trapezius) develops a trigger point, it refers pain up the side of the neck and head causing a headache. Active myofascial trigger points in the muscles of the shoulder, neck, and face are a common source of headaches.

Factors commonly cited as predisposing to trigger point formation include but are not limited to de-conditioning, poor posture, repetitive mechanical stress, mechanical imbalance (e.g. leg length inequality), joint disorders, non-restorative sleep and vitamin deficiencies.

After forming, trigger points develop two phases, active and latent. The active, painful phase of the trigger point is the one which produces the unrelenting, debilitating pain symptoms and which motivates people to seek relief. The active trigger point hurts when pressed with a finger and causes pain around it and in other areas. It causes the muscle in which it is located to be weak and limits the flexibility thereof. The active trigger point referral symptom may feel like a dull ache, a deep-pressing pain, a burning sensation, or a sensation of numbness and fatigue.

The latent phase of a trigger point lies quietly in muscles, sometimes for years. Latent trigger points are very common. Unless the trigger point is pressed on and tenderness is felt, a latent phase of a trigger point can go undetected. Latent trigger points generally do not cause pain unless compressed. Many things can cause a trigger point to become active, such as an old injury that periodically re-surfaces (e.g. “trick knee” or lower back “going out”) may very likely be due to latent trigger points “waking up” and becoming active when aggravated by muscle overload, a cold draft, fatigue, infection, illness or stress.

Since a trigger point is the contraction mechanism of the muscle locked into a shortened position, the treatment of the trigger point involves unlocking that contraction mechanism (sarcomere). Trigger point pressure release involves applying pressure with a finger or other instrument to the trigger point and increasing the pressure as the trigger point “releases” and softens. Using this technique, trigger points are relieved primarily by applying pressure to receptors in the nervous system long enough to deprive the trigger point of its oxygen supply and inactivate muscle spasms. Pressure is applied with a thumb, finger, knuckle, palm or elbow depending on the size, depth and thickness of the muscle being compressed. There are many variations on this technique and a skilled practitioner often must choose which is right for each patient and muscle treated. Most trigger points are easy to detect by locating the pain, applying pressure and experiencing the subsequent pain release. However, if the pain is referred, the real source of the same is usually from a trigger point located in another part of the body. For example, a referred pain in the wrist, forearm and/or hand can be caused by a primary source trigger point located in the region of the shoulder blade. Thus, treatment for such pain requires treatment of the primary source trigger point and not the localized referred pain point.

Traditionally there are various self-applied exercises that an individual can perform which do not require the presence or assistance of an attendant or masseuse. These exercises often involve the use of some type of device such as a simple roller. Rollers used for self-myofascial release and massage therapy also help develop balance and alignment. These rollers are generally resilient rollers of materials such as rubber or heat-sealed EVA foams and are available in different lengths, diameters and surface textures. Conventional foam rollers can, to some extent, compress soft tissue. Using these rollers in various fashions, such as performing simple exercises in which the individual rolls the roller against a part of the user's body may improve blood flow and tissue flexibility. However, the effect is often limited and relatively superficial and these type rollers do not provide the deeper and thorough massage effect necessary to achieve effective myofascial release to a variety of muscles.

There therefore still exits a need for mechanical massage devices to correct the deficiencies of the prior art. In particular, the massage device disclosed herein provides a user with a combination of muscle therapy tools within a single spherical unit. The tool can be used for a variety of muscle therapy routines, such as, strength, energy, mobility, flexibility, relaxation, repair and relief. A subject using the combination multi-tool massage device disclosed herein can select the area of the body he or she wishes to target, thereby providing a deep and thorough massage effect necessary to achieve effective myofascial release to any muscle having a trigger point therein.

### SUMMARY OF THE INVENTION

In light of the foregoing, it is an object of the present invention to provide a combination multi-tool massage device in which one or more individual massage tools are assembled into a main spherical body, wherein the spherical body is itself a separate massage tool. It will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It can also be an object of the present invention to provide a combination multi-tool massage device in which one or more individual massage tools are assembled into a main spherical body, and wherein the spherical body is composed of a first hemispherical half and a second hemispherical half that engage and disengage one another, wherein the spherical body is configured to include one or more individual and distinct massage tools held in a fixed position inside the spherical body when the first hemispherical half and the second hemispherical are engaged. Each hemispherical half can independently be used as a separate and distinct (relative to the spherical body and the other tools disclosed herein) massage tool.

In part, the present invention can be directed to a combination multi-tool massage device in which one or more individual cylindrical roller massage tools are assembled into a main spherical body. Each cylindrical roller massage tool can be used as a distinct and separate massage tool.

In part, the present invention can also be directed to a combination multi-tool massage device in which one or more individual cylindrical roller massage tools are assembled into a main spherical body, and wherein the one or more cylindrical roller massage tools can have one or two removable end caps on the axial ends thereof, wherein each of the removable end caps can provide a distinct and separate massage tool.

In part, the present invention can also be directed to a combination multi-tool massage device in which one or more individual massage tools are assembled into a main spherical body, and wherein the one or more massage tools of the multi-tool massage device independently have one or more projections on an outer surface thereon, wherein the projections are configured to mimic a body part, such as a thumb, an elbow, a knuckle or a palm.

In part, the present invention can further be directed to a method of providing an effective massage to an area of superficial and deep tissue such as, for example, muscles of a human user, the area of superficial and deep tissue being in need of therapy, comprising the steps of a) simultaneously contacting a tool of the invention with both the area of superficial and deep tissue in need of therapy and a rigid surface; and b) moving the area of superficial and deep tissue in need of therapy over the tool of the invention while maintaining sufficient pressure between the tool and the area of superficial and deep tissue in need of therapy so as to roll the tool against both the rigid surface and the area of superficial and deep tissue in need of therapy, or press the tool against the area of superficial and deep tissue in need of therapy, for a time sufficient to administer the effective massage.

Other objects, features, benefits and advantages of the present invention will be apparent from this summary and the following descriptions of certain embodiments, and will be readily apparent to those skilled in the art having knowledge of various myofascial therapeutic devices. Such objects, features, benefits and advantages will be apparent from the above as taken into conjunction with the accompanying examples, figures and all reasonable inferences to be drawn therefrom. The disclosures in this application of all articles and references, including patents, are incorporated herein by reference.

### BRIEF DESCRIPTION OF THE DRAWINGS

FIG. 1 depicts a spherical body of a combination multi-tool massage device. FIG. 1A is a perspective view of the spherical body; FIG. 1B is a side-view of an outer shell of a first hemispherical half of the spherical body; and FIG. 1C is a top view looking into the outer shell of the first hemispherical half of the spherical body.

FIG. 2 depicts an exploded view of the inner core of a first hemispherical half and a second hemispherical half of the spherical body.

FIG. 3 depicts an inner core of the first hemispherical half of a spherical body of a combination multi-tool massage device. FIG. 3A is a top view of the inner core of the first hemispherical half of the spherical body; FIG. 3B is a side-view of the inner core of the first hemispherical half of the spherical body; and FIG. 3C is a perspective view of the inner core of the first hemispherical half of the spherical body.

FIG. 4 depicts an inner core of the second hemispherical half of a spherical body of a combination multi-tool massage device. FIG. 4A is a top view of an inner core of the second hemispherical half of the spherical body; FIG. 4B is a side-view of the inner core of the second hemispherical half of the spherical body; and FIG. 4C is a perspective view of the inner core of the second hemispherical half of the spherical body.

FIG. 5 depicts a first cylindrical roller. FIG. 5A is a top view of the first cylindrical roller; FIG. 5B is a side-view of the outer shell of the first cylindrical roller, and FIG. 5C is a perspective view of the outer shell of the first cylindrical roller.

FIG. 6 depicts an inner core of the first cylindrical roller. FIG. 6A is a top view of the inner core of the first cylindrical roller; FIG. 6B is a side-view of the inner core of the first cylindrical roller; and FIG. 6C is a perspective view of the inner core of the first cylindrical roller.

FIG. 7 depicts a second cylindrical roller. FIG. 7A is a top view of the outer shell of the second cylindrical roller; FIG. 7B is a side-view of the outer shell of the second cylindrical roller, and FIG. 7C is a perspective view of the outer shell of the second cylindrical roller.

FIG. 8 depicts an inner core of the second cylindrical roller. FIG. 5A is a top view of the inner core of the second cylindrical roller, FIG. 8B is a side-view of the inner core of the second cylindrical roller, and FIG. 8C is a perspective view of the inner core of the second cylindrical roller.

FIG. 9 depicts an example of a first end cap that fits radially into a first axial end of the second cylindrical roller. FIG. 9A is a top view of the first end cap; FIG. 9B is a side-view of the first end cap; and FIG. 9C is a perspective view of the first end cap.

FIG. 10 depicts an example of a second end cap that fits radially into a second axial end of the second cylindrical roller. FIG. 10A is a top view of the second end cap while FIG. 10B is a perspective view of the second end cap.

FIG. 11 depicts a hexagonal-shaped projection. FIG. 11A is a top view of the hexagonal-shaped projection showing length and width; FIG. 11B is a side-view of the hexagonal-shaped projection showing height at 900; and FIG. 11C is a side-view of the hexagonal-shaped projection showing height at a maximum degree of variance.

FIG. 12 depicts a rounded chevron-shaped projection. FIG. 12A is a top view of the rounded chevron-shaped projection showing length and width; FIG. 12B is a side-view of the rounded chevron-shaped projection showing height at 900; and FIG. 12C is a side-view of the rounded chevron-shaped projection showing height at a maximum degree of variance.

FIG. 13 depicts a rounded triangle-shaped projection. FIG. 13A is a top view of the rounded triangle-shaped projection showing length and width; FIG. 13B is a side-view of the rounded triangle-shaped projection showing height at 900; and FIG. 13C is a side-view of the rounded triangle-shaped projection showing height at a maximum degree of variance.

FIG. 14 depicts using the spherical ball of the invention as a massage device to administer a slow deep pulse into the skin and superficial tissue, as well as into deep tissue such as a muscle or muscle groups, of the body of a user during self-myofascial therapy. FIG. 14A illustrates the user focusing his/her body weight (through the back of a thigh) on the top of the spherical body to produce a deep portion of the slow pulse movement; FIG. 14B illustrates the user releasing the pressure of his/her bodyweight from FIG. 14A and simultaneously pulling the hips away from the spherical body; and FIG. 14C depicts repeating the step of FIG. 14A.

FIG. 15 depicts a rapid shallow pulse demonstrated on a user's hamstring muscle of the right leg using the spherical body as a massage device. FIG. 15A illustrates the beginning phase of the rapid shallow pulse, wherein the user lightly depresses the leg approximately 2 inch on the spherical body; FIG. 15B illustrates the user releasing the pressure delivered during the phase shown in FIG. 15A while simultaneously pulling the hips away approximately 2 inch from the spherical body; FIG. 15C illustrates the second shallow pulse into the muscle as the hip is pulled back farther and the spherical body is moved closer to the user's knee; and FIG. 15D illustrates the user releasing the pressure delivered during the phase shown in FIG. 15C while simultaneously pulling the hips away approximately 2 inch from the spherical body.

FIG. 16 illustrates a first hemispherical half of the spherical body being used as a massage device. FIG. 16A illustrates the user in the start position with bodyweight pressure being applied to the first hemispherical half of the spherical body; FIG. 16B illustrates the user pivoting the upper leg at the hip joint, resulting in the knee moving closer the user's chest; and FIG. 16C illustrates the completion of the movement shown in FIG. 16B.

FIG. 17 illustrates a first cylindrical roller massage device larger cylinder being used. FIG. 17A illustrates a user applying the weight of the lower leg onto the surface of the first cylindrical roller massage device for approximately 1 second; FIG. 17B illustrates the user pulling the leg back proximally on the first cylindrical roller massage device over approximately 5 seconds; and FIG. 17C illustrates the completion of the movement shown in FIG. 17B after approximately 10 seconds.

FIG. 18 illustrates using the first cylindrical roller massage device together with a piece of cloth. FIG. 18A illustrates the first cylindrical roller massage device used with a piece of cloth, wherein the user is applying downward pressure onto the upper leg muscle just above the knee; FIG. 18B illustrates the user pulling the first cylindrical roller massage device back proximally over time; and FIG. 18C illustrates the completion of the movement shown in FIG. 18B.

FIG. 19 illustrates a second cylindrical roller massage device being used. FIG. 19A illustrates the user pressing the second cylindrical roller massage device into the deep tissue of the upper leg; FIG. 19B illustrates the user maintaining the pressure shown in FIG. 19A while twisting the second cylindrical roller into the deep tissue; and FIG. 19C illustrates rotating the second cylindrical roller massage device 90°.

FIG. 20 illustrates a first removable end cap being used as a massage device. FIG. 20A illustrates the user making initial contact with and pressing into the tissue near a trigger point in the forearm muscle; FIG. 20B illustrates “drawing” a circular line of pressure around the target spot using the end cap on the second cylindrical roller, FIG. 20C illustrates the user sliding the tool into the middle of the circle created and pressing to his/her own pain tolerance; and FIG. 20D depicts the “drawing” of a circular line of pressure with the end cap as shown in FIG. 20B. [0037]1 FIG. 21 depicts the first inner core and the second inner core engaged and the surfaces thereof defining the spherical cavity.

### DETAILED DESCRIPTION OF THE INVENTION

As it relates to certain non-limiting embodiments, the present invention provides a combination multi-tool massage device in which one or more individual massage tools are assembled into a main spherical body. In essence, the multi-tool massage device provides a user with a combination of muscle therapy tools that can be housed within a single unit. The device is used for a variety of myofascial (or muscle) therapy routines, such as, strength, energy, mobility, flexibility, relaxation, repair and relief.

### Tools of the Massage Device

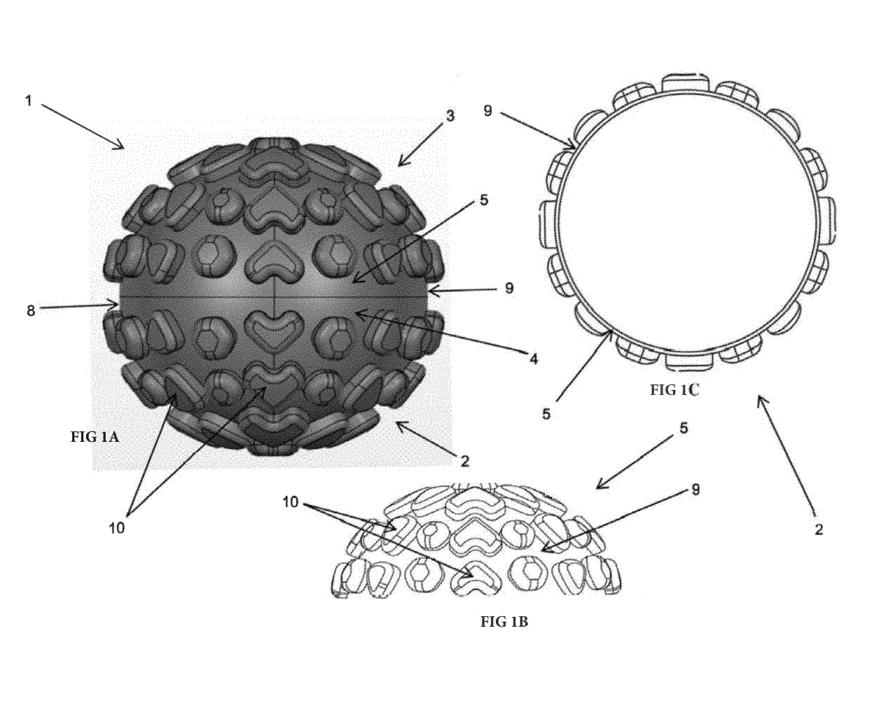

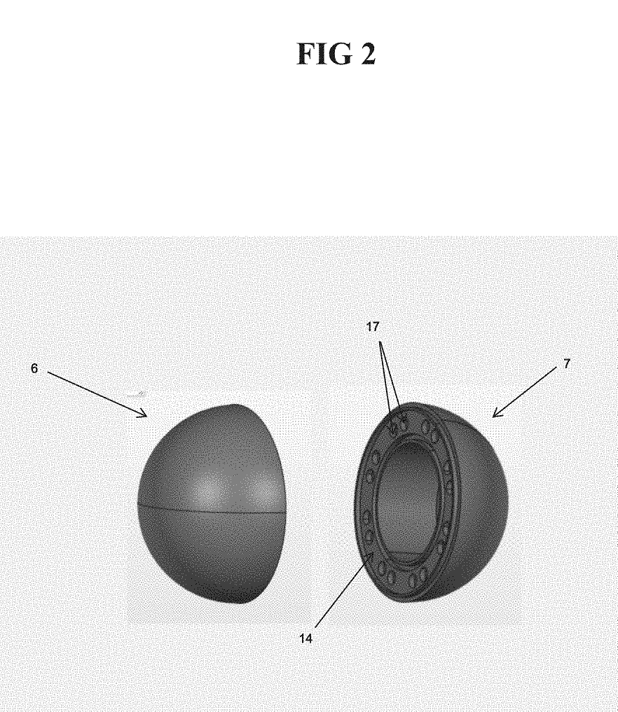

Referring to FIG. 1 and FIG. 2, the spherical body 1 (see FIG. 1A) is comprised of a first hemispherical half 2 (see FIG. 1A and FIG. 1C) and a second hemispherical half 3 (see FIG. 1A) that engage and disengage one another. The first hemispherical half 2 and the second hemispherical half 3 have a first outer shell 4 (see FIG. 1A) and a second outer shell 5 (see FIG. 1A and FIG. 1C), respectively, and a first inner core 6 and a second inner core 7 (see FIG. 2), respectively. The first outer shell 4 and the second outer shell 5 have a first outer surface 8 and a second outer surface 9, respectively, the first outer surface 8 and the second outer surface 9 comprising a first plurality of one or more projections 10 thereon. Additionally, the first plurality of one or more projections 10, either alone or in combination, are configured to mimic a body part, wherein the first outer surface 8 and the second outer surface 9 are symmetrical. The body part that the first plurality of one or more projections 10 are configured to mimic include, but are not limited to, an elbow, a thumb, a knuckle, a palm or a combination thereof.

The first inner core 6 and the second inner core 7 (see FIG. 2) are also substantially rigid and configured to include one or more individual and distinct massage tools held in a fixed position inside the spherical body 1 when the first hemispherical half 2 and the second hemispherical half 3 are engaged. Also, the first inner core 6 and the second inner core 7 extend medially from a first inner surface and a second inner surface of the first outer shell 4 and the second outer shell 5, respectively, for a certain width to form a first annular shelf 13 and a second annular shelf 14, wherein the first inner core 6 and the second inner core 7 define a spherical cavity 15 (see FIG. 21) when the first hemispherical half 2 and the second hemispherical half 3 are engaged to form the spherical body 1.

The spherical body 1 is preferably durable, with the inner cores 6, 7 of the hemispherical halves 2, 3 being made of more rigid material than the outer shells 4, 5. Preferably, the outer shells 4, 5 are made of a durable polymer with elastomeric properties such as, for example, a thermoplastic elastomer (a TPE). Examples of a suitable TPE include but are not limited to styrene block copolymers, thermoplastic olefins, elastomeric alloys, thermoplastic polyurethanes, thermoplastic copolyesters and thermoplastic polyamides. The inner cores 6, 7 are secured to the respective inner surfaces of the outer shells 4, 5, preferably by permanent means such as, for example, an adhesive. The inner cores 6, 7 thereby provide structural support for the outer shells 4, 5 and the entire spherical body 1 in general. Preferably, the inner cores 6, 7 are made of a rigid material such as, for example, polyvinyl chloride (PVC) and the like.

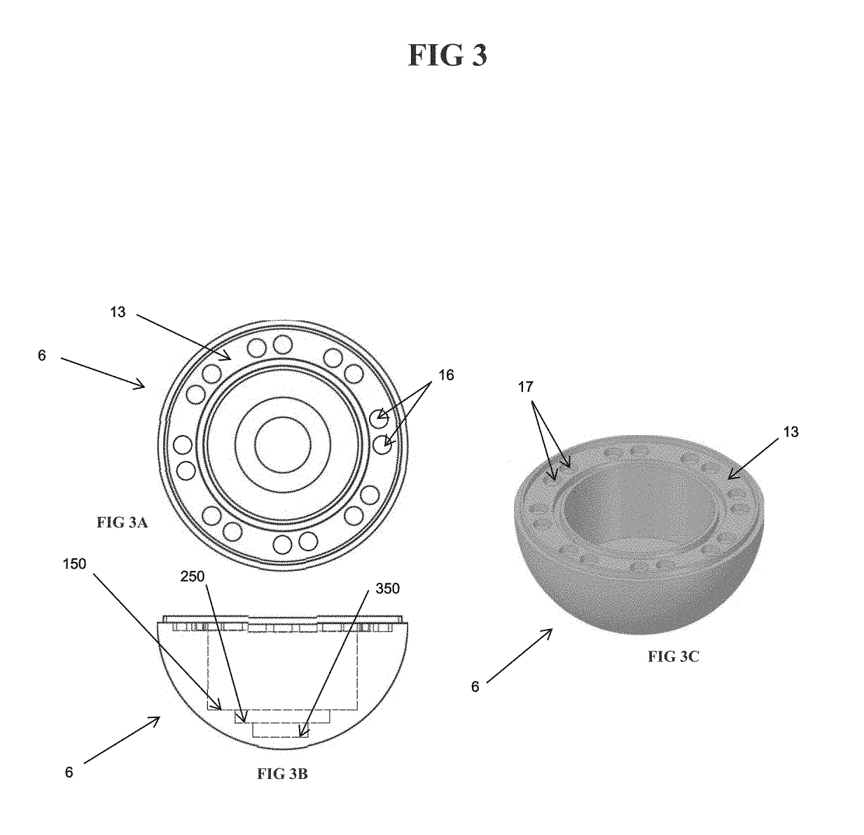

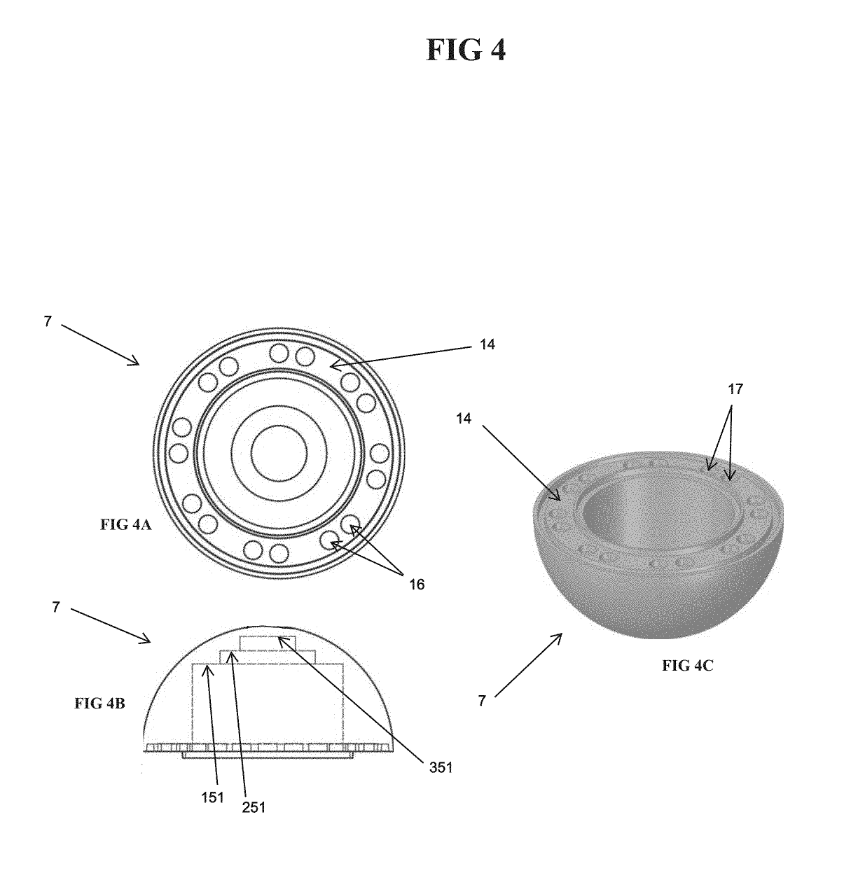

The first hemispherical half 2 and the second hemispherical half 3 can be engaged by a variety of means. Preferably, the first hemispherical half 2 and the second hemispherical half 3 are engaged magnetically by magnets 16 (see FIG. 3A and FIG. 4A) fixedly attached in the first annular shelf 13 and the second annular shelf 14. More preferably, the magnets are fixedly attached in pairs in recess cavities 17 in the first annular shelf 13 and the second annular shelf 14, as depicted in FIG. 3C and FIG. 4C. As shown in FIG. 3A (for the first hemispherical half) and FIG. 4A (for the second hemispherical half), each pair of magnets 16 in the first annular shelf 13 are arranged such that they are aligned with a pair of magnets 16 in the second annular shelf 14 in a manner such that opposite polarities of the two magnets 16 align, thereby keeping the first hemispherical half 2 and the second hemispherical half 3 engaged to one another. Alternatively, or in combination with the magnetically engaged hemispherical halves, the first hemispherical half 2 and the second hemispherical half 3 can be detachably assembled by means of two locking members designed to engage with each other, such as for example, wherein the locking members comprise an annular ridge formed on one of the first annular shelf 13 or the second annular shelf 14 projecting outwardly to fit within an annular groove on the other of the first annular shelf 13 or the second annular shelf 14. Where these locking members are used in combination with the magnets 16, the annular ridge and the annular groove are positioned laterally to the magnets 16 mounted in the first annular shelf 13 and the second annular shelf 14.

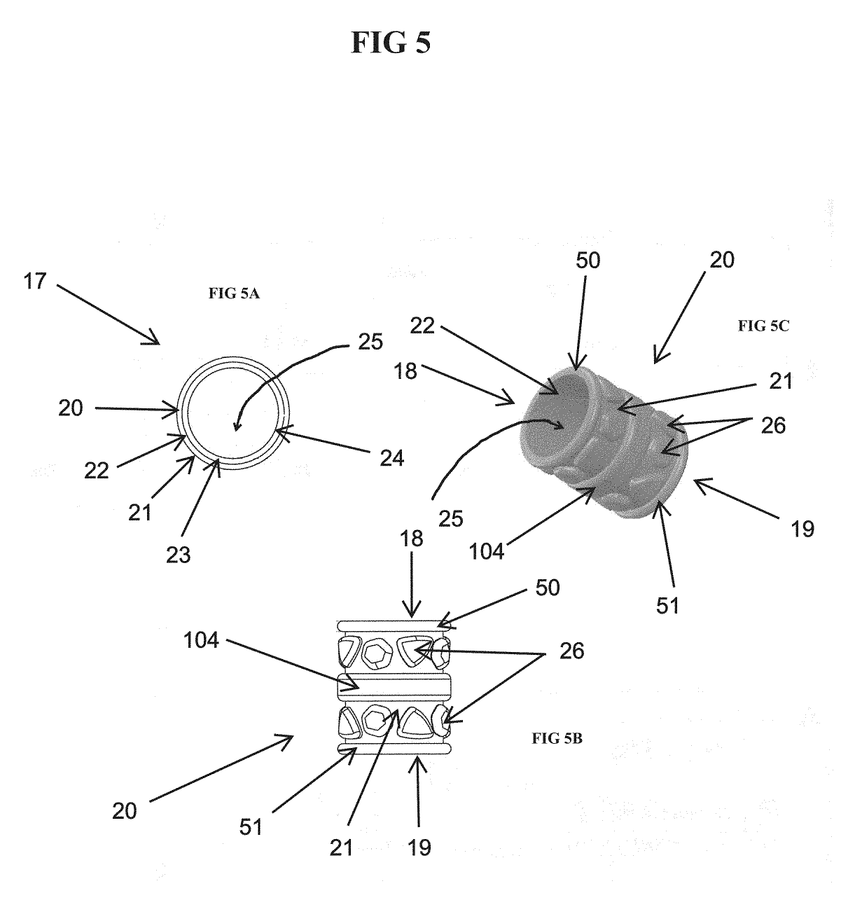

Referring now to FIG. 5, the one or more individual massage tools that can be assembled into the main spherical body 1 is a first cylindrical roller massage device (or first cylindrical roller) 17 (see FIG. 5A) having a first cylindrical roller first axial end 18 (see FIG. 5B and FIG. 5C) and a first cylindrical roller second axial end 19 (see FIG. 5B and FIG. 5C). Both the first cylindrical roller first axial end 18 and the first cylindrical roller second axial end 19 have first axial end rib 50 and a second axial end rib 51, respectively, that runs along the entire circumference of the respective axial ends 18, 19. The first axial end rib 50 and the second axial rib 51 are used both for guidance for the user, as well as assist in the self-myofascial therapy according to the invention, as discussed in detail below. Because of the relatively small size of the first cylindrical roller 17, a guidance system is needed to avoid the tool from getting lost underneath the user. The first axial end rib 50 and the second axial rib 51 are designed to physically remind the user where the tool is under his/her body. The first cylindrical roller 17 is like a mini-foam roller or lacrosse ball, and the first axial end rib 50 and the second axial rib 51 allow the user more control during slow, deep movements. The curved nature of the first axial end rib 50 and the second axial rib 51 provides a surface for pushing through tissue and makes treating muscles or tendons close to the bone or other sensitive areas very effective. The first cylindrical roller has an outer shell 20 having an outer surface 21 and an inner surface 22. The length of the first cylindrical roller 17 extends between the first cylindrical roller first axial end 18 and the first cylindrical roller second axial end 19. Additionally, an inner core 23 with an inner surface 24 is secured to the inner surface of the outer shell 22, and preferably made of more rigid material than the outer shell 20, the inner surface of the inner core 24 defines a hollow core interior 25 extending throughout a first cylindrical roller core length and having a hollow core interior diameter. The first cylindrical roller first axial end 18 is configured to rest against and fit into a first recess 150 (see FIG. 3B) of the spherical cavity 15 (see FIG. 21) and the first cylindrical roller second axial end 19 is configured to rest against and fit into a second recess 151 (see FIG. 4B) of the spherical cavity 15 such that the first cylindrical roller massage device 17 is held in a first fixed position within the spherical cavity 15.

The first cylindrical roller 17 is preferably rigid, with the inner core 23 being made of more rigid material than the outer shell 20. Preferably, the outer shell 20 is made of durable polymer with elastomeric properties, such as for example, a thermoplastic elastomer (a TPE). Examples of a suitable TPE include but are not limited to styrene block copolymers, thermoplastic olefins, elastomeric alloys, thermoplastic polyurethanes, thermoplastic copolyesters and thermoplastic polyamides. The outer surface 21 of the outer shell 20 also comprises a second plurality of one or more projections 26 thereon, the second plurality of one or more projections 26, either alone or in combination, configured to mimic a body part (see FIG. 5B and FIG. 5C). The body part that the second plurality of one or more projections 26 are configured to mimic include, but are not limited to, an elbow, a thumb, a knuckle, a palm or a combination thereof. While the second plurality of one or more projections 26 mimic a body part similar to the first plurality of one or more projections 10, the second plurality of one or more projections 26 can be the same or different than the first plurality of one or more projections 10 in both shape and dimension. Preferably, while the second plurality of one or more projections 26 are identical in shape as the first plurality of one or more projections 10, the second plurality of one or more projections 26 are smaller in dimension than the first plurality of one or more projections 10. Regardless, the dimension of each projection (both first and second plurality) is consistent with the depth that a muscle therapist can inflict on a subject's skin, muscle, fascial and other human superficial and deep tissue (by superficial tissue is meant the thin layer of loose fatty connective tissue underlying the dermis and binding it to the parts beneath and by deep tissue is meant that tissue which lies beneath the superficial tissue, including muscles), depending on the therapy needed and as discussed in detail below. Preferably, the outer surface 21 of the outer shell 20 also comprises a medial rib 104 that runs the entire circumference of the first cylindrical roller 17, the medial rib 104 also utilized in the self-myofascial therapy according to the invention, as discussed in detail below (see FIG. 5B and FIG. 5C).

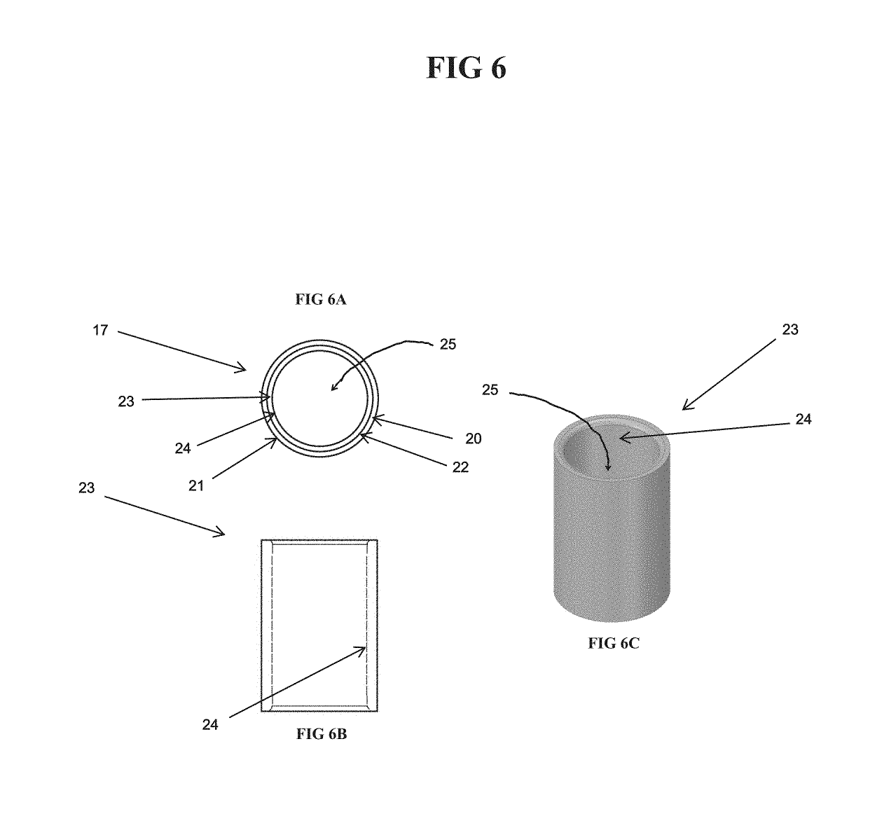

FIG. 6A, FIG. 6B and FIG. 6C depict the inner core 23 of the first cylindrical roller 17. As stated above, the inner core 23 is secured to the inner surface 22 of the outer shell 20, preferably by permanent means such as, for example, an adhesive. The inner core 23 thereby provides structural support for the outer shell 20 and the entire first cylindrical roller 17 in general. Preferably, the inner core 23 is made of a rigid material as, for example, polyvinyl chloride (PVC) and the like.

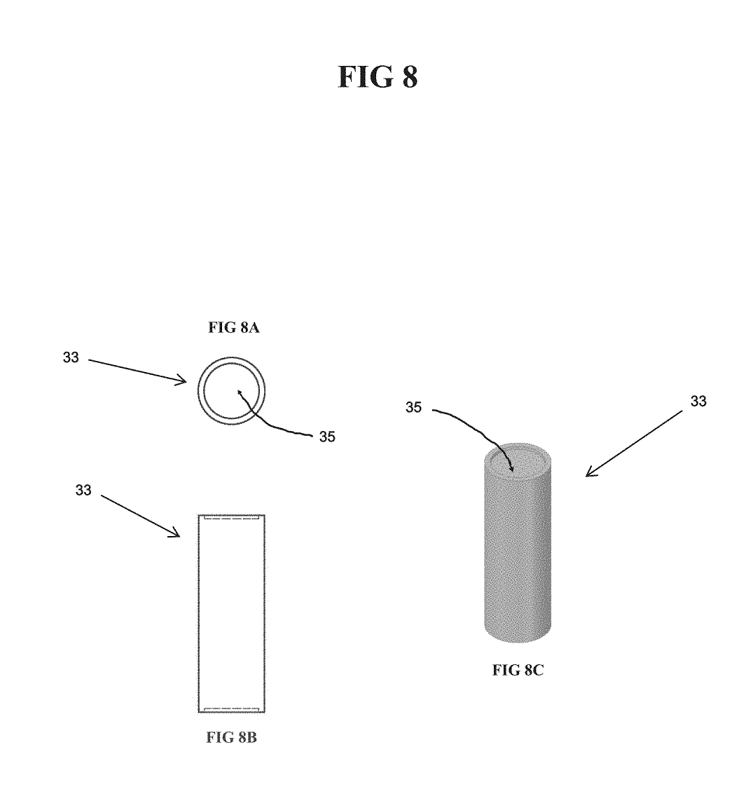

In an embodiment, another of the one or more individual massage tools that can be assembled into the main spherical body 1 is a second cylindrical roller massage device (or second cylindrical roller) 27. The second cylindrical roller 27 is preferably configured to slide into the hollow core interior 25 of the first cylindrical roller 17. This is achieved, for example, by allowing the second cylindrical roller 27 to have a total diameter substantially similar to the hollow core interior 25 diameter of the first cylindrical roller 17 such that the second cylindrical roller 27 is held in a fixed position within the same, and therefore held in a fixed position within the spherical cavity 15 (or a second fixed position within the spherical cavity 1, wherein the first fixed position therein is that of the first cylindrical roller 17). The second cylindrical roller 27 can be solid or have a hollow inner core, but more preferably, the second cylindrical roller 27 is solid throughout, i.e. has a solid core interior 35 (see FIG. 8 unlike the first cylindrical roller 17.

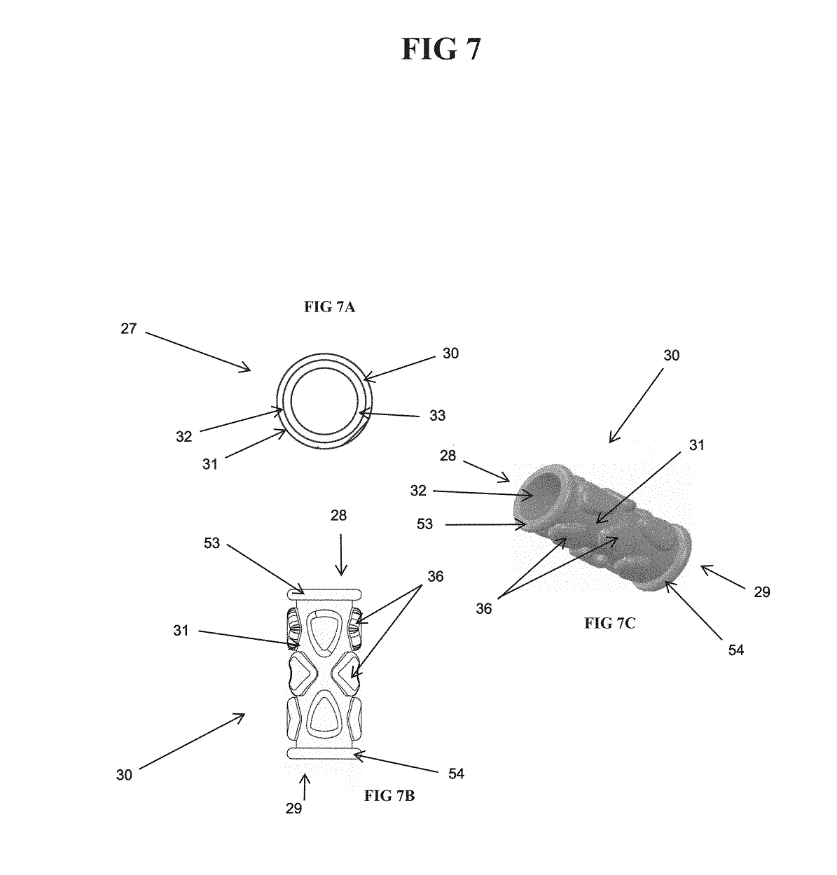

FIG. 7A, FIG. 7B and FIG. 7C show the second cylindrical roller 27 having a second cylindrical roller first axial end 28 and a second cylindrical roller second axial end 29. Similar to the first cylindrical roller 17, both the second cylindrical roller first axial end 28 and the second cylindrical roller second axial end 29 have a first axial end rib 53 and a second axial end rib 54, respectively, that runs along the entire circumference of the respective axial ends 28, 29. The first axial end rib 53 and the second axial end rib 54 are used to target ropey tendons and to relieve muscle and other deep tissue tension next to and under bones. The height of the first axial end rib 53 and the second axial end rib 54 makes it easier for the user to safely angle the tool into position during treatment. This angle allows for a precise gliding compression along sensitive areas. Because of its cylindrical shape, the second cylindrical roller 27 can also perform gliding compression or “rolling” for, but not limited to, forearms, hands, calves, and feet. The second cylindrical roller furthermore has an outer shell 30 having an outer surface 31 and an inner surface 32. The length of the second cylindrical roller 27 extends between the second cylindrical roller first axial end 28 and the second cylindrical roller second axial end 29. Moreover, and referring to FIG. 5A, FIG. 8B and FIG. 8C, an inner core 33 is secured to the inner surface of the outer shell 30 of the second cylindrical roller 27, and preferably made of more rigid material than the outer shell 30. In addition, the second cylindrical roller first axial end 28 is configured to rest against and fit into a third recess 250 (see FIG. 3B) of the spherical cavity 15 and the second cylindrical roller second axial end 29 is configured to rest against and fit into a fourth recess 251 (see FIG. 4B) of the spherical cavity 15 such that the second cylindrical roller massage device 27 is held in a first fixed position within the spherical cavity 15. It is therefore preferable that the second cylindrical roller 27 have a longer length than the first cylindrical roller 17, since the third and fourth recesses 150, 151 are deeper than the first and second recesses 250, 251 (see FIG. 3B and FIG. 4B).

The second cylindrical roller 27, like the first cylindrical roller, is preferably rigid, with the inner core 33 being made of more rigid material than the outer shell 30 thereof. Preferably, the outer shell 30 is made of durable polymer with elastomeric properties, such as for example, a thermoplastic elastomer (a TPE). Examples of a suitable TPE include but are not limited to styrene block copolymers, thermoplastic olefins, elastomeric alloys, thermoplastic polyurethanes, thermoplastic copolyesters and thermoplastic polyamides. The outer surface of the outer shell 31 also comprises a third plurality of one or more projections 36 thereon, the third plurality of one or more projections 36, either alone or in combination, configured to mimic a body part (see FIG. 7B and FIG. 7C). The body part that the third plurality of one or more projections 36 are configured to mimic include, but are not limited to, an elbow, a thumb, a knuckle, a palm or a combination thereof. While the third plurality of one or more projections 36 mimic a body part similar to the first plurality of one or more projections 10 and the second plurality of one or more projections 26, the third plurality of one or more projections 36 can be the same or different than either or both of the first plurality of one or more projections 10 and the second plurality of one or more projections 26 in both shape and dimension. Preferably, while the third plurality of one or more projections 36 are identical in shape as the first plurality of one or more projections 10 and the second plurality of one or more projections 26, the third plurality of one or more projections 36 are smaller in dimension than both the first plurality of one or more projections 10 and the second plurality of one or more projections 26. Regardless, the dimension of each projection, similar to the first plurality of one or more projections 10 and the second plurality of one or more projections 26, is consistent with the depth that a muscle therapist can inflict on a subject's skin, muscle, fascial and other human superficial and deep tissue, depending on the therapy needed and as discussed in detail below.

FIG. 8A, FIG. 8B and FIG. 5C depict the inner core 33 of the second cylindrical roller 27. As stated above, the inner core 33 is secured to the inner surface of the outer shell 32, preferably by permanent means such as, for example, an adhesive. The inner core 33 thereby provides structural support for the outer shell 30 and the entire second cylindrical roller 27 in general. Preferably, the inner core 23 is made of a rigid material as, for example, polyvinyl chloride (PVC) and the like.

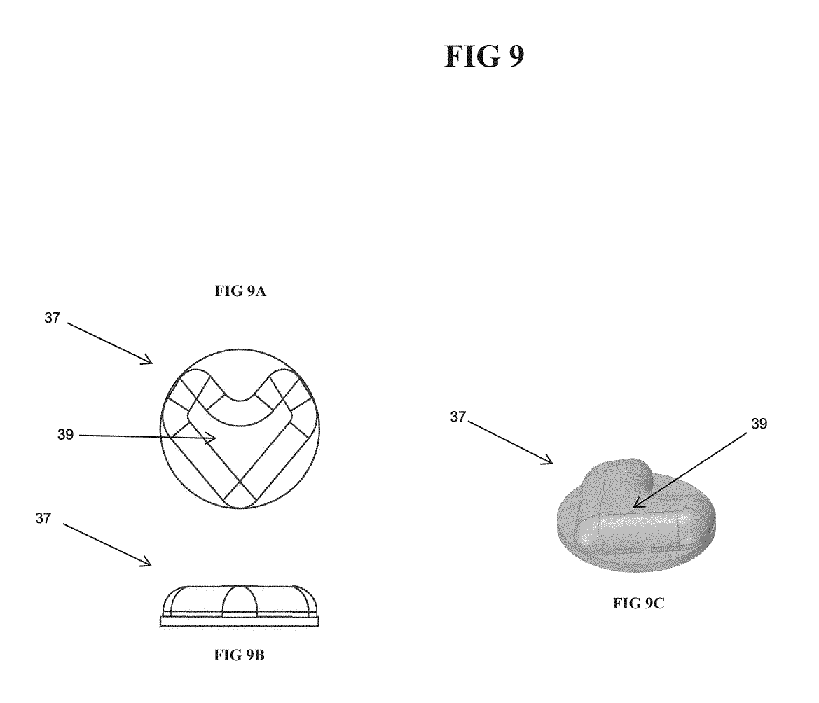

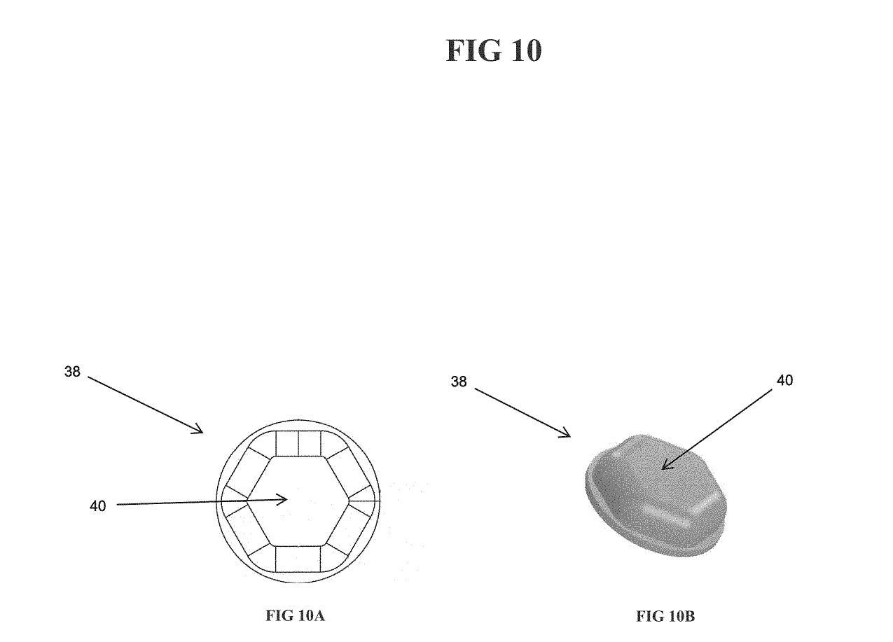

The spherical body massage device 1 of the instant invention can also house other tools other than a roller assembled therein. Preferably, such other tools can include, but are not limited to, a single projection massage device or a second ball massage device. More preferably, the single projection massage device can be an end cap at the end of one of or both the first cylindrical roller 17 or the second cylindrical roller 27. In an embodiment, FIG. 9A, FIG. 9B and FIG. 9C depict a first end cap 37 that fits radially onto the first axial end 18 of the first cylindrical roller 17 or the first axial end 28 of the second cylindrical roller 27, even more preferably the second cylindrical roller 27. Likewise, FIG. 10A and FIG. 10B depict a second end cap 38 that fits radially onto the second axial end 19 of the first cylindrical roller 17 or the second axial end 29 of the second cylindrical roller 27, even more preferably the second cylindrical roller 27. The first end cap 37, when preferably secured onto the first axial end 28 of the second cylindrical roller 27, is configured to rest against and fit into a fifth recess 350 (see FIG. 3B) of the spherical cavity 15, and the second end cap 38, when preferably secured onto the second axial end 29 of the second cylindrical roller 27, is configured to rest against and fit into a sixth recess 351 (see FIG. 4B) of the spherical cavity 15 such that the first end cap 37 and the second end cap 38 are held in a first fixed position within the spherical cavity 15. It is therefore noted that the fifth and sixth recesses 350, 351 are deeper than either the third and fourth recesses 150, 151 and the first and second recesses 250, 251 (see FIG. 3B and FIG. 4B).

The first end cap 37 and the second end cap 38 each have a same or different projection 39, 40 thereon configured to mimic a body part. The body part that the projections 39, 40 on each of the end caps 37, 38 are configured to mimic independently include, but are not limited to, an elbow, a thumb, a knuckle, a palm or a combination thereof. While the projections 39, 40 on each of the end caps 37, 38 mimic a body part similar to the first plurality of one or more projections 10, the second plurality of one or more projections 26, and the third plurality of one or more projections 36 (collectively the preceding projections), the projections 39, 40 on each of the end caps 37, 38 can be the same or different than any of the preceding projections in both shape and dimension. While each of the single projections 39, 40 on each of the end caps 37, 38 are identical in shape as the preceding projections, the projections 39, 40 on each of the end caps 37, 38 can vary in dimension relative to the other preceding projections. Regardless, the dimension of the projections 39, 40 on each of the end caps 37, 38, similar to the preceding projections, is consistent with the depth that a muscle therapist can inflict on a subject's skin, muscle, fascial and other human superficial and deep tissue, depending on the therapy needed and as discussed in detail below. Even more preferably, the projection 39 on the first end cap 37 is different than the projection 40 on the second end cap 38. The end caps 37, 38 can be detached by a user from the axial ends 18, 19 of the first cylindrical roller 17 or the axial ends 28, 29 of the second cylindrical roller 27, allowing for the replacement of a different end cap with a distinct projection, depending on the therapy. For example, the end caps 37, 38 can be held in place by one or more screws that can be removed by a user. Alternatively, the end caps 37, 38 can be permanently secured to the axial ends 18, 19 of the first cylindrical roller 17 or the axial ends 28, 29 of the second cylindrical roller 27 such as, for example, an adhesive.

Also, more preferably, the second ball massage device has a diameter small enough to be held in a fixed position inside the spherical body 1. The second ball massage device can also have an aperture throughout the diameter of the spherical body 1 such that the first cylindrical roller 17 and/or the second cylindrical roller 27 can be held in a fixed position therein. Even more preferably, the first cylindrical roller 17 and the second cylindrical roller 27 can additionally be held in a fixed position within the spherical body 1 in that the first axial ends 18, 19 of the first cylindrical roller and the second cylindrical roller 28, 29, respectively, are configured to rest against and fit into the first recess 150 and the third recess 250, respectively, of the spherical cavity 15, and the second axial ends 18, 19 of the first cylindrical roller and the second cylindrical roller 28, 29, respectively, are configured to rest against and fit into the second recess and the fourth recess 150, 251, respectively, of the spherical cavity 15.

### Projections

The invention also provides projections on the spherical body and the one or more massage tools that it can house, such as the first cylindrical roller 17, the second cylindrical roller 27, the end caps 37, 38 and the like. The projections play a significant role in the type of therapy the user employs. While both the shape and dimension thereof are important, the actual shape of the projection is critical. The shape of the projection determines the digital or anatomical compression that is mimicked when the correct pressure is applied. The dimension or size of the projection is not as critical, as different therapists have different sized fingers, hands and the like. To this end, by “projection” is meant a part of a surface that juts out or is not flush with the rest of the surface.

a. Hexagonal-Shaped Projection (“Hexagon”)

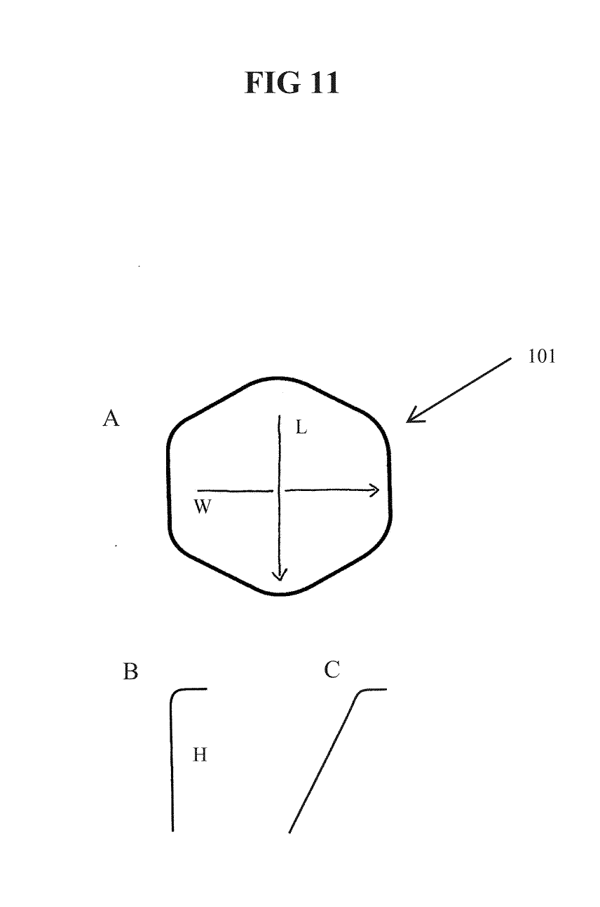

A first projection that can represent one of the first plurality of one or more projections 10, one of the second plurality of one or more projections 26, one of the third plurality of one or more projections 36, the first end cap projection 39, and/or the second end cap projection 40 is the hexagonal-shaped projection 101 (hereinafter “the hexagon”) depicted in FIG. 11A. As can be seen in FIG. 11A, the hexagon 101 is generally shaped in the form of a hexagon with round edges. FIG. 11B shows the height H at an angle of 90° (measured from a standard x, y graph), while FIG. 11C shows the height H at a maximum degree of variance. Preferably, the maximum degree of variance can be up to 25° (from 90°), or an angle of no less than 65°. By including a degree of variance, more surface area is added to the hexagon 101. By adding surface area to the hexagon 101, the intensity of the stretch of the muscle being treated is decreased.

In a specific non-limiting embodiment of a hexagon 101, a first hexagon 101a is projected on the outer surfaces 8, 9 of the first and second outer shells 4, 5 of the first and second hemispherical halves 2, 3, respectively. Preferably, the first hexagon 101a is projected at the apex of the first and second hemispherical halves 2, 3 (i.e. one on each hemispherical half). The first hexagon 101a is designed to mimic the surface, shape, angle, size and hardness of a human's elbow and palm. Its height and distance between the surrounding shapes allows for maximum muscle tissue penetration when a user puts his/her weight on to the spherical body 1. The rounded edges represent the rounded corners of the human elbow or palm. The dimensions of the first hexagon 101a are proper to be effective while allowing the user to practice self-myofascial therapy safely. Specifically, the dimensions of the first hexagon 101a can vary, depending on several factors such as, for example, the overall size of the spherical body 1, although the first hexagon 101a on each hemispherical half 2, 3 is identical. In a specific non-limiting embodiment, and referring to FIG. 11, the length L of the first hexagon 101a measures 28.58 mm from point to point (see FIG. 11A), the width W measures 25.1 mm from flat edge to flat edge (see FIG. 11A), and the height H is 7.79 mm from the base to the top (see FIG. 11B). Preferably, the first hexagon 101a is the largest in dimension of all the hexagon-shaped projections 101 present on the outer surfaces 8, 9 of the first and second hemispherical halves 2, 3.

In another non-limiting embodiment, a second hexagon 101b is projected on the outer surfaces 8, 9 of the first and second outer shells 4, 5 of the first and second hemispherical halves 2, 3, respectively. Preferably, the second hexagon 101b appears six to ten times along the medial edge of the first and second hemispherical halves 2, 3, more preferably eight times along the medial edge of the first and second hemispherical halves 2, 3. The second hexagon 101b is also designed to mimic the surface, shape, angle, size and hardness of a human's elbow and palm. Its height and distance between the surrounding shapes allows for maximum muscle tissue penetration when a user puts his/her weight on to the spherical body 1. The rounded edges represent the rounded corners of the human elbow or palm. As with the first hexagon 101a, the dimensions of the second hexagon 101b are proper to be effective while allowing the user to practice self-myofascial therapy safely. Specifically, the dimensions of the second hexagon 101b can vary, depending on several factors such as, for example, the overall size of the spherical body 1, although the second hexagons 101b on each hemispherical half 2, 3 are identical. In a specific non-limiting embodiment, and referring again to FIG. 11, the length L of the second hexagon 101b measures 21.35 mm from point to point (see FIG. 11A), the width W measures 21.55 mm from flat edge to flat edge (see FIG. 11A), and the height H is 7.79 mm from the base to the top (see FIG. 11B).

In yet another non-limiting embodiment, a third hexagon 101c is projected on the outer surfaces 8, 9 of the first and second outer shells 4, 5 of the first and second hemispherical halves 2, 3, respectively. Preferably, the third hexagon 101c is present six to ten times from the apex first hexagon 101a to, an including, the medial edge of the first and second hemispherical halves 2, 3, more preferably eight times from the apex first hexagon 101a to, an including, the medial edge of the first and second hemispherical halves 2, 3. The third hexagon 101c is again designed to mimic the surface, shape, angle, size and hardness of a human's elbow and palm. Its height and distance between the surrounding shapes allows for maximum muscle tissue penetration when a user puts his/her weight on to the spherical body 1. The rounded edges represent the rounded corners of the human elbow or palm. As with the first hexagon 101a and the second hexagon 101b, the dimensions of the third hexagon 101c are proper to be effective while allowing the user to practice self-myofascial therapy safely. Specifically, the dimensions of the third hexagon 101e can vary, depending on several factors such as, for example, the overall size of the spherical body 1, although the third hexagons 101c on each hemispherical half 2, 3 are identical. In a specific non-limiting embodiment, and again referring to FIG. 11, the length L of the third hexagon 101c measures 15.13 mm from point to point (see FIG. 11A), the width W measures 15.39 mm from flat edge to flat edge (see FIG. 11A), and the height H is 7.79 mm from the base to the top (see FIG. 11B). Preferably, the third hexagon 101c is the smallest in dimension of all the hexagon-shaped projections 101 present on the outer surfaces 8, 9 of the first and second hemispherical halves 2, 3, and the width W of all hexagons on the first and second spherical half 2, 3 are the same dimension. When either the first hemispherical half 2 or the second hemispherical half 3 is used as an independent massage tool, the hexagons 101 collectively provide a stable surface with several, and preferably seven, points of contact are generated to facilitate and manipulate multiple muscles and joints of the body.

In still another non-limiting embodiment, a fourth hexagon 101d is projected on the outer surface 21 of the outer shell 20 of the first cylindrical roller 17. Preferably, the fourth hexagon 101d is projected two or more times on the first cylindrical roller 17 such that the repetition of the fourth hexagon 101d is configured to allow spreading of the surrounding soft tissue (“soft tissue” includes tendons, ligaments, fascia, skin, fibrous tissues, fat, synovial membranes, muscles, nerves and blood vessels) of the human body during use. The fourth hexagon 101d is also designed to mimic the surface, shape, angle, size and hardness of a human's elbow and palm. The rounded edges represent the rounded corners of the human elbow or palm. As with the previous hexagons 101 described above, the dimensions of the fourth hexagon 101d are proper to be effective while allowing the user to practice self-myofascial therapy safely. Specifically, the dimensions of the fourth hexagon 101d can vary, depending on several factors such as, for example, the overall size of the first cylindrical roller 17, although the fourth hexagons 101d on the first cylindrical roller 17 are identical. In a specific non-limiting embodiment, and referring to FIG. 11, the length L of the fourth hexagon 101d measures 20.46 mm from point to point (see FIG. 11A), the width W measures 18.22 mm from flat edge to flat edge (see FIG. 11A), and the height H is 4.87 mm from the base to the top (see FIG. 11B). Preferably, the fourth hexagon 101d is the only hexagon-shaped projection 101 present on the outer surface 21 of the outer shell 20 of the first cylindrical roller 17.

In yet another non-limiting embodiment, a fifth hexagon 101e is projected on the outer surface 31 of the outer shell 30 of the second cylindrical roller 27. Preferably, the fifth hexagon 101e is projected one or more times on the second cylindrical roller 27 and more preferably has a more concave surface than the other four hexagons 101a, 101b, 101c and 101d allowing the user to put more pressure on the deep tissue in the areas of the body with ropey or inflamed tendons, i.e. forearms, wrists, ankles and neck. Moreover, the fifth hexagon's 101e height, combined with its distance from the other shapes, allow the user deeper and controlled therapy using his/her own body weight. The fifth hexagon 101e is designed to mimic the surface, shape, angle, size and hardness of a human's elbow and palm. The rounded edges represent the rounded corners of the human elbow or palm. The dimensions of the fifth hexagon 101e are proper to be effective while allowing the user to practice self-myofascial therapy safely. Specifically, the dimensions of the fifth hexagon 101e can vary, depending on several factors such as, for example, the overall size of the second cylindrical roller 27, although the fifth hexagons 101e on the second cylindrical roller 27 are identical. In a specific non-limiting embodiment, and referring again to FIG. 11, the length L of the fifth hexagon 101e measures 22.83 mm from point to point (see FIG. 11A), the width W measures 24.02 mm from flat edge to flat edge (see FIG. 11A), and the height H is 6.01 mm from the base to the top (see FIG. 11B). Preferably, the fifth hexagon 101e is the only hexagon-shaped projection 101 present on the outer surface 31 of the outer shell 30 of the second cylindrical roller 27.

In another non-limiting embodiment, a single sixth hexagon 101f is projected on the first end cap 39 and/or the second end cap 40. Preferably, the sixth hexagon 101f is projected on just one of the first end cap 39 or the second cap 40, providing direct pressure with a soft and flat surface for large tender spots (as used herein, “tender spots” is synonymous with “knot” and “trigger point”) and multiple angled sides for smaller points of contact. The sixth hexagon 101f is designed to manipulate surrounding deep tissue first using a rolling, shallow pulse around the tender point and then the flat surface or center to press directly on the tender spot of the muscle. The hexagon 101f on the first or second end cap 39, 40 overcomes the deficiencies of the prior art trigger point tools that are very sharp with little surface area (i.e. easy for a user to fall off of) by providing the same sharp angles but including the comfort of wider space for the same result with less intensity. The sixth hexagon 101f is also designed to mimic the surface, shape, angle, size and hardness of a human's elbow and palm. The rounded edges represent the rounded corners of the human elbow or palm. The dimensions of the sixth hexagon 101f are proper to be effective while allowing the user to practice self-myofascial therapy safely. Specifically, the dimensions of the sixth hexagon 101f can vary, depending on several factors such as, for example, the overall size of the first and/or second end caps 39, 40. In a specific non-limiting embodiment, and referring to FIG. 11, the length L of the sixth hexagon 101f measures 23.65 mm from point to point at the base (15.60 mm from point to point at the apex of the hexagon 101f) (see FIG. 11A), the width W measures 21.65 mm from flat edge to flat edge at the base (see FIG. 11A), and the height H is 5.90 mm from the base to the top (see FIG. 11B). Each side of the hexagon 101f at the base measures 6.90 mm wide.

b. Rounded Chevron-Shaped Projection

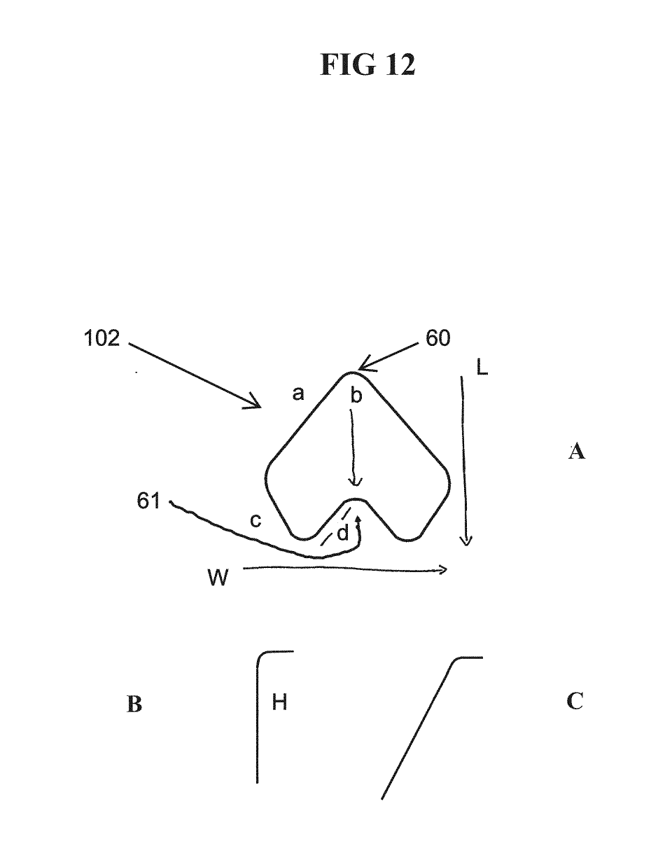

A second projection that can represent one of the first plurality of one or more projections 10, one of the second plurality of one or more projections 26, one of the third plurality of one or more projections 36, the first end cap projection 39, and/or the second end cap projection 40 is the rounded chevron-shaped projection 102 (hereinafter “the chevron”) depicted in FIG. 12A. The chevron 102 is designed to mimic a human elbow from two different sides of the elbow, the rounded point 60 and the depression 61 (see FIG. 12A). The rounded point 60 digs into the deep tissue as the wedge side (characterized with the length “a” in FIG. 12A) widens to push deep tissue to the sides, much like a plow through snow. The depression 61 mimics the posterior medial elbow. The depression 61 is used to hold the targeted deep tissue in place giving the user more direct control while moving through sensitive areas. As can be seen in FIG. 12A, the chevron 102 is generally shaped in the form of a chevron (or heart-like shape) with round edges. FIG. 12B shows the height H at an angle of 90° (measured from a standard x, y graph), while FIG. 12C shows the height H at a maximum degree of variance. Preferably, the maximum degree of variance can be up to 250 (from 90°), or an angle of no less than 65°. By including a degree of variance, more surface area is added to the chevron 102. By adding surface area to the chevron 102, the intensity of the stretch of the muscle being treated is decreased.

In a specific non-limiting embodiment of a chevron 102, a first chevron 102a is projected on the outer surfaces 8, 9 of the first and second outer shells 4, 5 of the first and second hemispherical halves 2, 3, respectively. Preferably, the first chevron 102a is projected three to five times, most preferably four times, on each of the first and second hemispherical halves 2, 3. The dimensions of the first chevron 102a are proper to be effective while allowing the user to practice self-myofascial therapy safely. Specifically, the dimensions of the first chevron 102a can vary, depending on several factors such as, for example, the overall size of the spherical body 1, although the first chevron 102a on each hemispherical half 2, 3 is identical. In a specific non-limiting embodiment, and referring to FIG. 12, the length L of the first chevron 102a measures 26.94 mm from the middle of the rounded point 60 to the middle of a bottom rounded point (see FIG. 12A), the width W measures 23.89 mm from the middle of a side point to the middle of the other side point (see FIG. 12A), the length of side “a” is 20.99 mm (for purposes of all measured lettered sides in this section, measurement is from the middle of a rounded point to the middle of another rounded point) (see FIG. 12A), the distance of “b” is 21.97 mm (see FIG. 12A), the length of side “c” is 11.4 mm (see FIG. 12A), the length of side “d” is 6.1 mm (see FIG. 12A), and the height H is 7.79 mm from the base to the top (see FIG. 12B). Preferably, the first chevron 102a is the largest in dimension of all the rounded chevron-shaped projections 102 present on the outer surfaces 8, 9 of the first and second hemispherical halves 2, 3.

In another non-limiting embodiment, a second chevron 102b is projected on the outer surfaces 8, 9 of the first and second outer shells 4, 5 of the first and second hemispherical halves 2, 3, respectively. Preferably, the second chevron 102b appears three to five times on the first and second hemispherical halves 2, 3, more preferably four times on the first and second hemispherical halves 2, 3. As with the first chevron 102a, the dimensions of the second chevron 102b are proper to be effective while allowing the user to practice self-myofascial therapy safely. Specifically, the dimensions of the second chevron 102b can vary, depending on several factors such as, for example, the overall size of the spherical body 1, although the second chevrons 102b on each hemispherical half 2, 3 are identical. In a specific non-limiting embodiment, and referring again to FIG. 12, the length L of the second chevron 102b measures 23.66 mm from the middle of the rounded point 60 to the middle of a bottom rounded point (see FIG. 12A), the width W measures 22.38 mm from the middle of a side point to the middle of the other side point (see FIG. 12A), the length of side “a” is 18.94 mm (see FIG. 12A), the distance of “b” is 19.91 mm (see FIG. 12A), the length of side “c” is 8.77 mm (see FIG. 12A), the length of side “d” is 5.67 mm (see FIG. 12A), and the height H is 7.79 mm from the base to the top (see FIG. 12B). [0064] in yet another non-limiting embodiment, a third chevron 102e is projected on the outer surfaces 8, 9 of the first and second outer shells 4, 5 of the first and second hemispherical halves 2, 3, respectively. Preferably, the third chevron 102e appears three to five times along the medial edge of the first and second hemispherical halves 2, 3, more preferably four times on the first and second hemispherical halves 2, 3. As with the first chevron 102a and the second chevron 102b, the dimensions of the third chevron 102c are proper to be effective while allowing the user to practice self-myofascial therapy safely. Specifically, the dimensions of the third chevron 102c can vary, depending on several factors such as, for example, the overall size of the spherical body 1, although the third chevrons 102c on each hemispherical half 2, 3 are identical. In a specific non-limiting embodiment, and referring again to FIG. 12, the length L of the third chevron 102c measures 19.13 mm from the middle of the rounded point 60 to the middle of a bottom rounded point (see FIG. 12A), the width W measures 15.25 mm from the middle of a side point to the middle of the other side point (see FIG. 12A), the length of side “a” is 15.25 mm (see FIG. 12A), the distance of “b” is 15.01 mm (see FIG. 12A), the length of side “c” is 6.90 mm (see FIG. 12A), the length of side “d” is 4.90 mm (see FIG. 12A), and the height H is 7.79 mm from the base to the top (see FIG. 12B). Preferably, the third chevron 102e is the smallest in dimension of all the chevron-shaped projections 102 present on the outer surfaces 8, 9 of the first and second hemispherical halves 2, 3, and the width W of all chevrons 102 on the first and second spherical half 2, 3 are the same dimension.

The alignment of the chevrons 102 on the first and second hemispherical halves 2, 3 is crucial, preferably three back-to-back (in a row from apex to median) and configured such that the rounded point 60 of one faces the depression 61 of another, more preferably with the point 60 of the first chevron 102a near the apex of the first and second hemispherical halves 2, 3 (the rounded point 60 pointing at and next to the first hexagon 101a; see FIG. 1A and FIG. 1B), and the third chevron 102c near the medial edge of the first and second hemispherical halves 2, 3. In this way, the alignment resembles that of a conveyor belt, as the first chevron 102a pushes through and begins the softening of the surrounding deep tissue, while the second chevron 102b (in between the first chevron 102a and the third chevron 102c) follows with a finer point on the knots and reaches deeper therein. The third chevron 102c in the “back-to-back” alignment allows for pin-point targeting without causing the treated muscle into protective reflex, reaction, or shooting pain. In sum, the depressions 61 allow the user an opportunity to pin a tender spot in the muscle while the rounded point 60 continues to separate the tender points.

In still another non-limiting embodiment, a fourth chevron 102d is projected on the outer surface 31 of the outer shell 30 of the second cylindrical roller 27. Preferably, the fourth chevron 102d is projected two or more times on the second cylindrical roller 27, more preferably four times, wherein two fourth chevrons 102d are next to each other with each rounded point 60 facing each other (see FIG. 7B). The fourth chevron 102d is positioned to cradle troubled areas such as, for example, knots (as used herein, knot is synonymous with tender spot and trigger point) during the twisting motion of muscle shearing. Because of the layout of the fourth chevron 102d, the user is left with a couple of options of intensity, namely pinning the knot between depression 61 (more aggressive), or pinning the knot between the two drops (less aggressive) leads to a wider spectrum of use and less likelihood of injury during treatment. As with the previous chevrons 102 described above, the dimensions of the fourth chevron 102d are proper to be effective while allowing the user to practice self-myofascial therapy safely. Specifically, the dimensions of the fourth chevron 102d can vary, depending on several factors such as, for example, the overall size of the first cylindrical roller 17, although the fourth chevrons 102d on the first cylindrical roller 17 are identical. In a specific non-limiting embodiment, and referring to FIG. 12, the length L of the fourth chevon 102d measures 22.10 mm from the middle of the rounded point 60 to the middle of a bottom rounded point (see FIG. 12A), the width W measures 24.28 mm from the middle of a side point to the middle of the other side point (see FIG. 12A), the length of side “a” is 16.55 mm (see FIG. 12A), the distance of “b” is 13.45 mm (see FIG. 12A), the length of side “c” is 7.73 mm (see FIG. 12A), the length of side “d” is 6.08 mm (see FIG. 12A), and the height H is 6.01 mm from the base to the top (see FIG. 12B). Preferably, the fourth chevron 102d is the only chevron-shaped projection 102 present on the outer surface 31 of the outer shell 30 of the second cylindrical roller 27. Also preferably, no chevron 102 is projected on the outer surface 21 of the outer shell 20 of the first cylindrical roller 17.

In another non-limiting embodiment, a single fifth chevron 102e is projected on the first end cap 39 and/or the second end cap 40. Preferably, the fifth chevron 102e is projected on just one of the first end cap 39 or the second cap 40, providing a more aggressive rounded point 60 than the points of the sixth hexagon 101f on the first end cap 39 and/or the second end cap 40. Both the sixth hexagon 101f and the fifth chevron 102e are trigger point relief tools, but the fifth chevron 102e offers a smoother longer rounded point 60 at the base. This gives the user more options for the type of pressure he/she wants and/or needs. The dimensions of the fifth chevron 102e are proper to be effective while allowing the user to practice self-myofascial therapy safely. Specifically, the dimensions of the fifth chevron 102e can vary, depending on several factors such as, for example, the overall size of the first and/or second end caps 39, 40. In a specific non-limiting embodiment, and referring again to FIG. 12, the length L of the fifth chevron 102e measures 21.88 mm from the middle of the rounded point 60 to the middle of a bottom rounded point (see FIG. 12A), the width W measures 24.14 mm from the middle of a side point to the middle of the other side point (see FIG. 12A), the length of side “a” is 16.83 mm (see FIG. 12A), the distance of “b” is 17.31 mm (see FIG. 12A), the length of side “c” is 9.44 mm (see FIG. 12A), the length of side “d” is 5.85 mm (see FIG. 12A), and the height H is 5.65 mm from the base to the top (see FIG. 12B).

c. Rounded Triangle-Shaped Projection

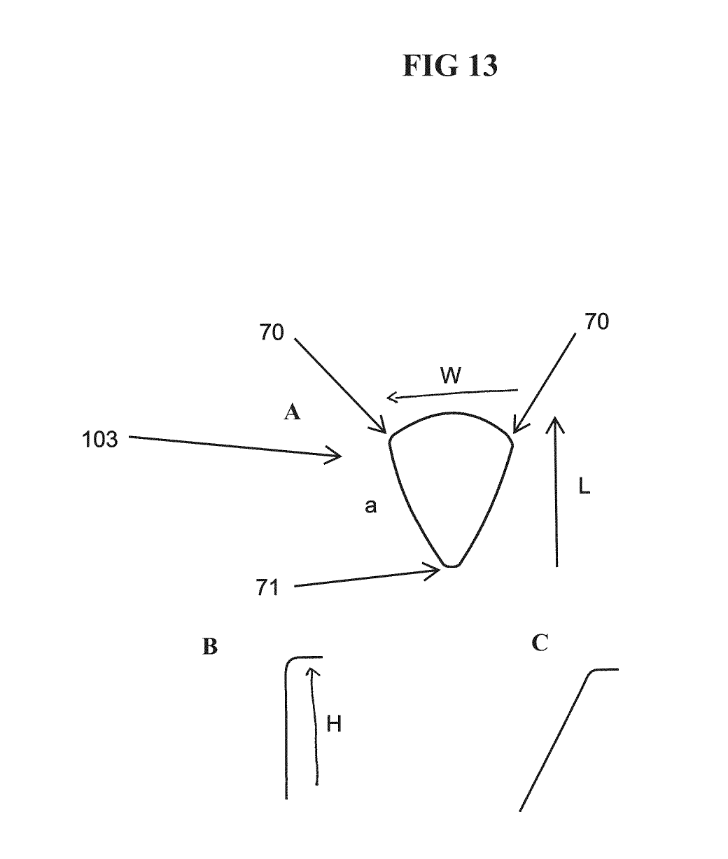

A third projection that can represent one of the first plurality of one or more projections 10, one of the second plurality of one or more projections 26, one of the third plurality of one or more projections 36, the first end cap projection 39, and/or the second end cap projection 40 is the rounded triangle-shaped projection 103 (hereinafter “the triangle”) depicted in FIG. 13A. The triangle consists of two soft, wide and rounded points 70 (hereinafter “wide point”) that meet to form a rounded short side. The triangle also has one tapered rounded point 71 (hereinafter “tapered point”). Between these points 70, 71 on each side are longer, concave sides. Designed to mimic the thumb pad, the sides of the triangle 103 gives a user the feel of reinforced thumbs, or rather when a thumb is stacked on another during muscle therapy treatment. The triangle 103 is used when trying to target a small area of deep tissue. The technique treats the deep tissue with minimal surface area because of the lateral pulling of such tissue by the triangle 103 pressing into the same. The tapered point 71 is designed to resemble the profile of a human thumb. Similar to the depression 61 of the chevron 102, the triangle 103 provides a softer “catch” to cradle or pin the knot when a user encounters a large patch of tight deep tissue. The concave sides are designed to slowly work into tight muscle while the tapered point 71 drives into and through muscle once it has been softened. As can be seen in FIG. 13A, the triangle 103 is generally shaped in the form of an isosceles triangle with round edges. FIG. 13B shows the height H at an angle of 90° (measured from a standard x, y graph), while FIG. 13C shows the height H at a maximum degree of variance. Preferably, the maximum degree of variance can be up to 250 (from 90°), or an angle of no less than 65°. By including a degree of variance, more surface area is added to the triangle 103. By adding surface area to the triangle 103, the intensity of the stretch of the muscle being treated is decreased.

In a specific non-limiting embodiment of a triangle 103, a first triangle 103a is projected on the outer surfaces 8, 9 of the first and second outer shells 4, 5 of the first and second hemispherical halves 2, 3, respectively. Preferably, the first triangle 103a is projected three to five times, most preferably four times, on each of the first and second hemispherical halves 2, 3. The dimensions of the first triangle 103a are proper to be effective while allowing the user to practice self-myofascial therapy safely. Specifically, the dimensions of the first triangle 103a can vary, depending on several factors such as, for example, the overall size of the spherical body 1, although the first triangle 103a on each hemispherical half 2, 3 is identical. In a specific non-limiting embodiment, and referring to FIG. 13, the length L of the first triangle 103a measures 25.48 mm from the middle of the rounded shorter side formed between the two wide points 70 to the middle of the tapered point 71 (see FIG. 13A), the width W measures 17.88 mm from the middle of a wide point 70 to the middle of the other wide point 70 (see FIG. 13A), the length of side “a” is 20.69 mm from the middle of a wide point 70 to the middle of the tapered point 71 (see FIG. 13A), and the height H is 7.79 mm from the base to the top (see FIG. 13B). Preferably, the first triangle 103a is the largest in dimension of all the rounded chevron-shaped projections 103 present on the outer surfaces 8, 9 of the first and second hemispherical halves 2, 3. [0070] in another non-limiting embodiment, a second triangle 103b is projected on the outer surfaces 8, 9 of the first and second outer shells 4, 5 of the first and second hemispherical halves 2, 3, respectively. The second triangle 103 preferably has a less concave rounded short side formed between the two wide points 70 to stop movement and allow for more “wide pressure”. Preferably, the second triangle 103b is projected three to five times, most preferably four times, on each of the first and second hemispherical halves 2, 3. The dimensions of the second triangle 103b are proper to be effective while allowing the user to practice self-myofascial therapy safely. Specifically, the dimensions of the second triangle 103b can vary, depending on several factors such as, for example, the overall size of the spherical body 1, although the second triangle 103b on each hemispherical half 2, 3 is identical. In a specific non-limiting embodiment, and referring to FIG. 13, the length L of the second triangle 103b measures 23.76 mm from the middle of the rounded shorter side formed between the two wide points 70 to the middle of the tapered point 71 (see FIG. 13A), the width W measures 18.91 mm from the middle of a wide point 70 to the middle of the other wide point 70 (see FIG. 13A), the length of side “a” is 17.04 mm from the middle of a wide point 70 to the middle of the tapered point 71 (see FIG. 13A), and the height H is 7.79 mm from the base to the top (see FIG. 13B).

In yet another non-limiting embodiment, a third triangle 103c is projected on the outer surfaces 8, 9 of the first and second outer shells 4, 5 of the first and second hemispherical halves 2, 3, respectively. Preferably, the third triangle 103c is projected three to five times, most preferably four times, on each of the first and second hemispherical halves 2, 3. The dimensions of the third triangle 103c are proper to be effective while allowing the user to practice self-myofascial therapy safely. Specifically, the dimensions of the third triangle 103c can vary, depending on several factors such as, for example, the overall size of the spherical body 1, although the third triangle 103c on each hemispherical half 2, 3 is identical. In a specific non-limiting embodiment, and referring to FIG. 13, the length L of the third triangle 103c measures 19.50 mm from the middle of the rounded shorter side formed between the two wide points 70 to the middle of the tapered point 71 (see FIG. 13A), the width W measures 17.84 mm from the middle of a wide point 70 to the middle of the other wide point 70 (see FIG. 13A), the length of side “a” is 13.45 mm from the middle of a wide point 70 to the middle of the tapered point 71 (see FIG. 13A), and the height H is 7.79 mm from the base to the top (see FIG. 13B).

When either the first hemispherical half 2 or the second hemispherical half 3 is used as an independent massage tool, the curvature of the triangles 103 cradle the user's joint and/or muscle for a secure surface during a series of pin-and-stretch movements. As the user gets closer to the medial edge, the triangles 103 on the first hemispherical half 2 or the second hemispherical half 3 provide a gliding compression stretch that preferably targets the neck, ankles, and hips. Preferably, the third triangle 103c is the smallest in dimension of all the triangle-shaped projections 103 present on the outer surfaces 8, 9 of the first and second hemispherical halves 2, 3, and the width W of all triangles 103 on the first and second spherical half 2, 3 are the same dimension. Also, the alignment of the triangles 103 on the first and second spherical half 2, 3, similar to the chevrons 102, is preferably three back-to-back (in a row from the rounded short side between the wide points 70 to the tapered point 71) and configured such that the tapered point 71 of one faces the rounded short side between the wide points 70 of another, more preferably with the rounded short side between the wide points 70 of the first triangle 103a near the apex of the first and second hemispherical halves 2, 3 (the rounded short side between the wide points 70 closest to the first hexagon 101a; see FIG. 1A and FIG. 1B), and the third triangle 103c near the medial edge of the first and second hemispherical halves 2, 3. [0073] in still another non-limiting embodiment, a fourth triangle 103d is projected on the outer surface 21 of the outer shell 20 of the first cylindrical roller 17. Preferably, the fourth triangle 103d is projected two or more times on the first cylindrical roller 17. Designed to resemble a thumb pad, the wedge side (characterized with the length “a” in FIG. 13A) provides for softening of the target deep tissue while the tapered point 71 digs into the pre-softened deep tissue. Because of the distance from the medial rib 104 (as defined and detailed below), the fourth triangle 103d provides an extra space for the user to trap, pinch and hold superficial tissue while maintaining control and depth into the body. The dimensions of the fourth triangle 103d are proper to be effective while allowing the user to practice self-myofascial therapy safely. Specifically, the dimensions of the fourth triangle 103d can vary, depending on several factors such as, for example, the overall size of the first cylindrical roller 17, although all of the fourth triangles 103d are identical. In a specific non-limiting embodiment, and referring to FIG. 13, the length L of the fourth triangle 103d measures 20.29 mm from the middle of the rounded shorter side formed between the two wide points 70 to the middle of the tapered point 71 (see FIG. 13A), the width W measures 17.98 mm from the middle of a wide point 70 to the middle of the other wide point 70 (see FIG. 13A), the length of side “a” is 14.60 mm from the middle of a wide point 70 to the middle of the tapered point 71 (see FIG. 13A), and the height H is 4.87 mm from the base to the top (see FIG. 13B).

In yet another non-limiting embodiment, a fifth triangle 103e is projected on the outer surface 31 of the outer shell 30 of the second cylindrical roller 27. Preferably, the fifth triangle 102e is projected two or more times on the second cylindrical roller 27, more preferably four times, wherein two fifth tringles 103e are next to each other (perpendicular to the two fourth chevrons 102d) with each tapered point 70 facing each other (see FIG. 7B). Because of the layout of the fourth chevrons 102d on the second cylindrical roller 27 discussed in detail above, the user is left with a couple of options of intensity, namely pinning the knot between two rounded points 60 of two fourth chevrons 102d (more aggressive) or pinning the knot between two tapered points 71 of two fifth triangles 103e (less aggressive). The fifth triangle 103e is shaped to resemble a human knuckle. The rounded short side between the wide points 70 to the tapered point 71 and height of the fifth triangle 103e make it easy for a user to locate the target area. With the tapered point 71 of the fifth triangle perpendicular and next to the rounded point of the fourth chevron 102d, the user can cradle and pacify the tender area. The fifth triangle 103e is also used as a backstop (pin or catch) for the first and second axial end ribs 53, 54 and the fifth hexagon 101e. This backstop is angled to corner a troubled knot of tissue with a larger cupping surface. The extra surface is meant to be a lesser intensity and adds greater stability to the muscle shearing movement. The fifth triangles 103e are taller (base to point) than the drops of the other tools to give the user a couple different options for surface area contact.

The dimensions of the fifth triangle 103e are proper to be effective while allowing the user to practice self-myofascial therapy safely. Specifically, the dimensions of the fifth triangle 103e can vary, depending on several factors such as, for example, the overall size of the second cylindrical roller 27, although all of the fifth triangles 103d are identical. In a specific non-limiting embodiment, and referring to FIG. 13, the length L of the fifth triangle 103e measures 26.43 mm from the middle of the rounded shorter side formed between the two wide points 70 to the middle of the tapered point 71 (see FIG. 13A), the width W measures 21.30 mm from the middle of a wide point 70 to the middle of the other wide point 70 (see FIG. 13A), the length of side “a” is 21.81 mm mm from the middle of a wide point 70 to the middle of the tapered point 71 (see FIG. 13A), and the height H is 6.01 mm from the base to the top (see FIG. 13B).

d. Medial Rib

As discussed above, the outer surface 21 of the outer shell 20 of the first cylindrical roller 17 comprises a medial rib 104 as a projection that runs the entire circumference of the first cylindrical roller 17 directly in the middle of the same in between the other projections (see FIG. 5B and FIG. 5C). The medial rib 104 is designed to be the width of a human knuckle and meant to “strip” muscle and other soft tissues. This is done by applying a significant amount of pressure into the soft tissue while moving through the same at a semi-rigorous to rigorous pace. This rigorous technique or muscle stripping is used for quicker recovery. The shape of the medial rib 104 also gives the user a variety of surfaces from a flat middle (less aggressive) to tapered corners that meet the outer surface 21 (more aggressive). METHODS OF USE FOR THE TOOLS OF THE MASSAGE DEVICE

The invention additionally provides a method of providing an effective massage to an area of superficial and deep tissue of a human user, the area of superficial and deep tissue being in need of therapy (hereinafter “tissue in need of therapy”), comprising the steps of a) simultaneously contacting a tool of the invention with both the tissue in need of therapy and a rigid surface; and b) moving the tissue in need of therapy over the tool of the invention while maintaining sufficient pressure between the tool and the tissue in need of therapy so as to roll the tool against both the rigid surface and the tissue in need of therapy, or press the tool against the tissue in need of therapy, for a time sufficient to administer the effective massage. The deep issue can include, for example, muscles or a muscle group.

The term “effective massage” as used herein means a massage, wherein the user contacts the tissue in need of therapy with one or more tools of the invention as described above, for sufficient length and intensity to provide a detectable reduction in the severity of either the pain in the tissue in need of therapy, or the pain perceived at a location other than the tissue in need of therapy (wherein the tissue in need of therapy is the source of the pain perceived), the pain caused by one or more of the following as measured subjectively by the user: inflammation, decreased blood flow, muscle strain, muscle tension or muscle fatigue. The time of use sufficient to provide an effective massage varies with the user and the type of therapy needed. Generally, shorter times of use can provide less satisfactory therapeutic results, while longer times of use can cause pain or stress on the tissue in need of therapy.

By the term “slow pulse” or “slow deep pulse” as used herein is meant a technique that delivers a slow deep pulse into the muscle and other body tissues. By pulse or pulsing is meant a rhythmic, movement-based somatic therapy. The slow pulse technique is designed to slowly break up the superficial muscle tissue/fascia to avoid the protective reflex of the body. Slow pulse allows the user to treat the deeper line of fibers through the entire length of muscle and surrounding tissues. This pulse is meant to deliver a pain sensation of 7 out of 10 on the pain scale. This hurts-but-feels-good level of “pain” allows the user to control his/her breath (exhale as the user pushes and applies pressure, and inhale as the user moves) and tempo to be most effective. Because this technique fails to cross the threshold of “too much pain, too soon”, the body has a chance to adapt to the pressure without reacting to the pain the next day or causing delayed onset muscle soreness (DOMS). If kept below this threshold, the body feels uninhibited by new movement and only feels as if it had a successful workout the day before.

By “pin-and-stretch” as used herein is meant a technique wherein some soft tissue is locked in place while stretching or lengthening the same soft tissue. Pin-and-stretch is a technique that pins a very small area of muscle or connective tissue while affecting the entire muscle length during application. This technique pins down or anchors the target point in the muscle then has the user actively pull away from the anchor point by using the strength of the antagonist, or opposite muscle, to stretch the tissue. Pin-and-stretch creates an interruption in the target muscle's length and therefore statically stretches the tissue from a shortened length. This static stretch allows the user to target any given length, depending on the position of the pin instead of performing a typical static stretch that pulls from origin to insertion. Because a static stretch does not untie the knots in a muscle, pin-and-stretch gives a user the ability to pressure treat the target area while intensifying the stretch of the tissue between the knot and joints. Pin-and-stretch focuses on mobility and poses very little difficulty for the user. This ease of use allows almost anyone with limitations to perform an effective stretch without fear of inducing flare up or risking further injury. This technique can be used unilaterally, i.e. one side of the body, or bilaterally, i.e. both sides of the body. Increasing the individual's bodyweight on the “pin” intensifies the stretch but is always controlled by the user. The technique is ideal for all experience levels, including those with limited mobility.

By the term “slow pulse pin-and-stretch” as used herein is meant a technique that combines a slow pulse technique with a pin-and-stretch element. Combining the two techniques allows the user to pulse into the muscle and other body tissue to slowly break up the superficial layers to gain access into the deeper tissues, then anchoring the same tissue before performing an active stretch movement. The benefit is it gives the user multiple opportunities to pin-and-stretch multiple points on any given length of muscle. Slow pulse pin-and-stretch is a technique a user performs for mobility and flexibility. Because of the active stretch nature of the technique, the user employs the strength of the antagonist muscle, i.e. the muscle opposite of the target muscle, to fire. As the antagonist muscle activates, the targeted muscle turns off, which in turn relieves tension on the muscle allowing for a full range of motion from the stretch.

By the term “rapid pulse” as used herein is meant a superficial technique that delivers a shallow rapid pulse through the top layers of fascia, muscle layers and other connective tissues for the purpose of energizing joints and relaxing muscle fibers. Rapid pulse applies pressure to achieve a pain threshold between 6 and 7 out of 10 on the pain scale. This moderately breaks up superficial tissues along multiple muscle lines. This mild technique can be utilized by all experience levels to increase movement. Rapid pulse applies stable pressure to the muscle and then releases the tissue enough to slightly move the tool down or up the muscle line before applying the same volume of pressure again. This application of pressure, followed by immediate release, creates a pulse with a cadence of pressure-release, pressure-release, etc. which the user repeats either up or down the entire targeted muscle line. Rapid pulse works best around sensitive areas or areas that have recently experienced trauma or are in the recovery process.

By the term “rapid pulse pin-and-stretch” as used herein is meant a technique that delivers a shallow, rapid pulse with a pin-and-stretch element. Combining the two allows the user to pulse into the superficial muscle tissues and then anchor the same tissue before performing an active stretch movement on the troubled area. Rapid pulse pin-and-stretch gives the user several opportunities to pin-and-stretch multiple points on any muscle length. The difference between this rapid (and shallow) pulse pin-and-stretch and the slow pulse pin-and-stretch is the depth and intensity of the stretch. The rapid pulse pin-and-stretch focuses on the superficial tissues and therefore is much less aggressive than the slow pulse pin-and-stretch. Ideal for flexibility and mobility, rapid pulse pin-and-stretch targets users whose range of motion is limited because of routine habits and/or past injuries.

By the term “slow pulse-short” as used herein is meant a technique that targets a very small length of muscle or tissue. This technique works in the same manner as the slow pulse, but pins and drags more of the superficial and deep tissue during the movement. This drag gives the user a localized, longitudinal pull on the tissue while delivering a deep pulse into the muscle tissue itself. For use around joints and smaller target areas, this short slow pulse gives the user complete control around areas of the body that are sensitive and more susceptible to the body's protective reflex. This technique is ideal when the goal is creating traction or space/separation in joints. Most short slow pulse movements only require the use of the user's body weight and can be done with minimal effort. More advanced forms of this technique are easily adaptable once the basics are mastered.

By the term “rapid pulse-short” as used herein is meant a technique that targets a very small length of muscle or connective tissue. This technique mirrors the rapid pulse but pins and drags more of the superficial tissue during movement. This drag gives the user a localized, longitudinal pull of the skin and fascia while delivering a shallow pulse into the connective tissue. For use around small, very sensitive target areas, this short rapid pulse breaks and stretches the body's tissue without going deep enough to aggravate or animate tissues that would initiate the body's protective reflex. This technique softens tender/sensitive areas near the muscular-tendon junction. Because these areas of the body are points that tend to take most of the body's movement stress, they can be very difficult to manage because of the over use trauma they may endure. Most of the short, rapid pulse movements require the user to use other muscles to (1) assist in the movement, (2) stabilize the body and (3) guide during movement. Rapid pulse-short requires a degree of difficulty during manipulation and is labeled an advanced technique. There are several areas of the body, i.e. forearm, anterior shoulder and bicep, where this technique can be practiced and perfected before moving on to other areas of the body.

By the term “rolling pin-and-stretch” as used herein is meant a technique that can be used on larger target areas within a muscle length. Like pin-and-stretch, this technique all a user to pin down a troubled area of muscle to stretch it from that point and then rolls to another point in the muscle so the user can repeat the pin-and-stretch from the new point. This technique can be done with points being as close together or as far apart from each other as the user desires. Because of the rolling element of the stretch, this technique is considered an entry level movement. Typically used for relaxation and mobility purposes, a user with mobility restrictions can find this technique useful when targeting sensitive areas in muscle tissue. Depending on the wanted result, a user can use this stretch with as little or as much pressure as desired. The rolling portion should achieve a 6-7 on the pain scale, while holding below a 7 during the stretch phase.

By the term “muscle stripping” as used herein is meant a technique that can be used on larger target areas and typically affects multiple muscle groups at one time. This technique requires a high degree of pressure during application and typically moves at a faster, more rigorous pace than other techniques. When applying this technique, a user begins by using a tool to apply pressure to the target area with a force equaling 6 or 7 on the pain scale. With firm contact, the user begins to move the tool along the length of the muscle in the direction of the muscle fiber at a quick tempo. This tempo depends on the user's pain threshold and the muscle areas being targeted. Muscle stripping strives to realign muscle tissue after rigorous activity or injury and is an advanced technique.

By the term “gliding compression” as used herein is meant a technique that is commonly used in self-care practices and most often referred to as “rolling out”. This technique allows a user to cover a large area of muscle by gliding or rolling from one end of the muscle to the other. This movement has several degrees of pressure that can be added to get into the deeper layers of tissue. When beginning, a user can apply his/her body weight on a tool to bring the pain sensation to a 6 on the pain scale. This amount of pressure allows the user to glide over the superficial tissue and break through the congestion in the fascial layers of the body. To lessen the likelihood of the body's protective response, the user will travel slowly over the tissue during this practice. For this treatment to be most effective, the user can increase the initial pain sensation to a 7 out of 10 on the pain scale and move slowly through the tissue. Gliding compression is most useful when the goal is to relax the target muscle or to increase flexibility with the adjacent joint.

By the term “muscle shearing” as used herein is meant a technique that is used for small target areas to repair work at or around the muscular tendinous junction. When applying this technique, the user presses a tool into the target area until the pain threshold reaches 7 on the pain scale and then “twists” the tool and the underlying tissue to create “torque” in the tissue and essentially causes a sensation most closely resembling a friction burn. This burn is the result of the superficial layers, in particular the skin and fascia, pulling away from each other. The twisting detaches the superficial tissues from the muscle below. The twisting nature of this technique causes the top layers of skin to turn red. Because of this, the technique is only practiced a few times over one area of the body to avoid breaking the skin and causing adhesions or irritations in those areas.

By the term “circular pressure-animated knot therapy” or “animated knot therapy” (“AKT”) as used herein is meant a technique used for pain relief of small target areas. These areas are most commonly referred to as knots and can, when aggravated, refer pain to other parts of the body. AKT presses into the tissue near a tender point in the muscle. This technique differs from others by “drawing” a circular line of pressure around the target spot using a continuous pulse movement with a massage tool, such as, for example, the end cap on the second cylindrical roller. The pulse movement maintains contact between the tissue and the tool to increase pressure and allow the user to control the tender spot of muscle. After circling and thereby defining the entire spot with pressure, the user then slides the tool into the middle of the circle and presses to his/her own pain tolerance, typically a 7-7.5 on the pain scale, for five seconds. This is repeated three times to ensure the tender muscle has enough relief before returning to activity. AKT is not to be confused with trigger point therapy, which uses sustained pressure to diffuse a trigger point flare up. AKT is unique as it warms the surrounding tissue to (1) ease the pull of the surrounding tissue, (2) prepare the target tissue and (3) direct pressure on the troubled area. The nature of AKT allows for a variety of users to utilize it irrespective of skill level or mobility restrictions.

The “pain scale” as used herein is a chart from 1-10 (with 0 being a reference point with no pain). The following provides some tangible example of the various levels that define the 1-10 pain scale: 1) very minor annoyance-occasional minor twinges; 2) minor annoyance-occasional; 3) annoying enough to be distracting; 4) can be ignored if really involved in work, but still distracting; 5) cannot be ignored for more than 30 minutes; 6) cannot be ignored for any length of time, but can still go to work and participate in social activities; 7) makes it difficult to concentrate and interferes with sleep; can still function with effort; 8) physical activity severely limited; can read and convene with effort; nausea and dizziness can occur; 9) unable to speak; crying out or moaning uncontrollable; pass out; and 10) unconscious (see http://compass.rehab/patient-resources/medical-pain-scale, incorporated herein by reference).

a. Methods for Spherical Body Massage Tool

In a specific non-limiting embodiment of the invention, the massage tool is the spherical body. The spherical body is designed for slow and deep pulse movements and can also be used for a rapid pulse technique, as well as a variety of pin-and-stretch techniques. Because of its size, the spherical body can reach the deeper troubled areas of the soft tissue without much effort. Its size also helps users who lack experience to use the spherical body as a starter tool. Moreover, spherical body proves highly effective for a user who has a more tender muscular skeletal system because it is effective regardless of the weight applied on the tool during use. An array of specifically designed projections, as detailed above, cover the spherical body. Each projection allows various layers of tissue to be broken up for different purposes, such as strength, pain relief and flexibility. The two hemispherical halves of the spherical body engage at the medial edge of each hemispherical half. This juncture leaves enough room between the hemispherical halves for the user to make full use of the spherical body without hitting his/her spinal processes.

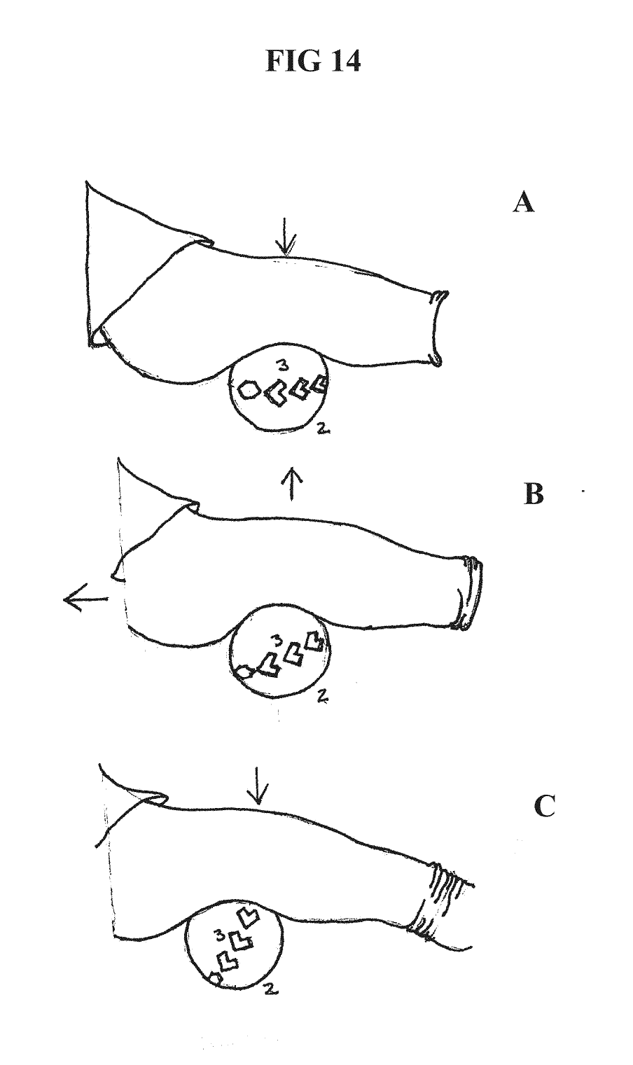

FIG. 14 as an example illustrates a user employing the spherical body to provide a slow deep pulse into the skin and superficial tissue and into individual muscle or muscle groups of the human body during self-myofascial therapy. FIG. 14A illustrates a user focusing his/her body weight on the top of the spherical body during the exhale of a breath. This is the deep portion of the slow pulse movement. FIG. 14B illustrates the user releasing the pressure of his/her bodyweight provided in FIG. 14A and simultaneously pulling the hips away from the spherical body during the inhale of the breath cycle. The release takes place first to avoid the body's natural reflex to protect against sudden pressure and allow the user to regain his/her breath. FIG. 14C illustrates the repetition of the step referred to in FIG. 14A, wherein the user is applying the focus of the bodyweight on top of the spherical body during the exhale portion of the breath cycle. This deep pulse pattern is repeated until the entire muscle length is treated. The size of the projections on the spherical body in FIG. 14 is not to scale and should not be used as a representation of accurate proportions. The illustration of the projections is merely to show the movement of the spherical body during the demonstration and is not a depiction of actual distance traveled during the use of the slow deep movement. Using this technique, a user travels approximately 1 inch along the soft tissue of the body per breath taken during exercise. The slow deep pulse movement is used to slowly hydrate the deep dried layers of muscle that are inhibiting the full range of motion and limiting use during movement activities. The slow pulse is for the use of adding strength to the muscle and tissue being treated by using pressure to break the dry surrounding tissue while creating a vacuum of negative pressure in the body causing a pull of water and nutrients into the spaces within the tissue just made available. Results can vary on many factors including height, weight, activity level, flexibility, extremity length and many other anatomical, physical and mental disabilities.

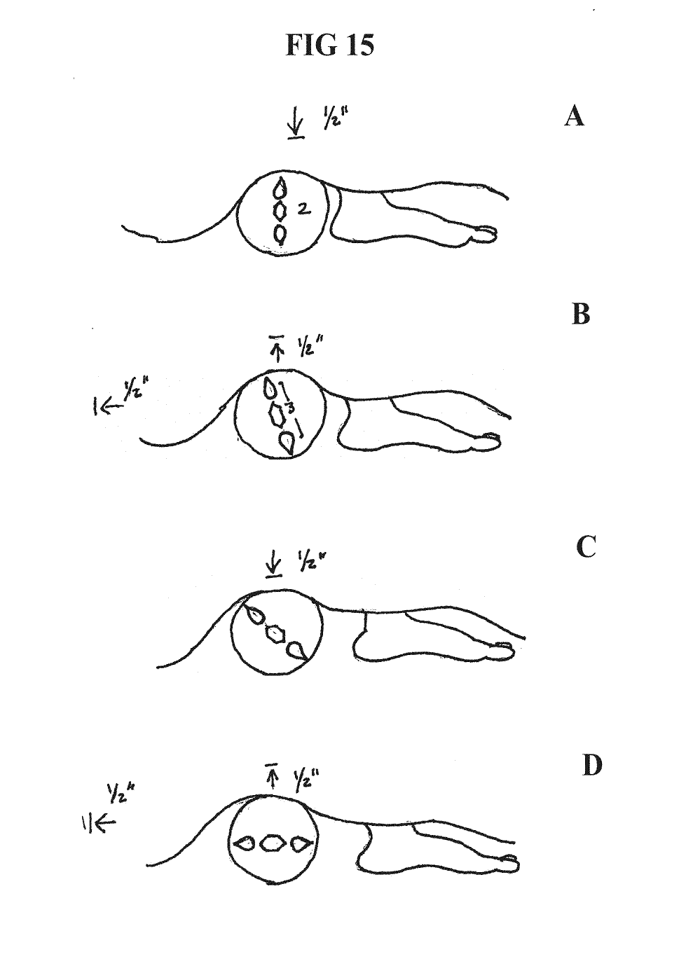

FIG. 15 illustrates an example of a rapid (and shallow) pulse demonstrated on a human's hamstring muscle of the right leg using the spherical body. FIG. 15A demonstrates the beginning phase of the rapid shallow pulse. The user lightly depresses the leg, approximately ½ inch into the superficial tissue, onto the spherical body during the first exhale of a six step staccato breath cycle. FIG. 151B illustrates the user releasing the pressure delivered during the phase shown in FIG. 15A while simultaneously pulling the hips away from the spherical body approximately Y/2 inch. During the lift and pull movement, the first breath of the staccato breath is held. FIG. 15C illustrates the second rapid (and shallow) pulse into the muscle as the hip is pulled back farther and the spherical body moves closer to the user's knee, and FIG. 15D illustrates the user releasing the pressure delivered during the phase shown in FIG. 15C while simultaneously pulling the hips away approximately 2 inch from the spherical body. This happens at the same moment of the second exhale of the staccato breath mentioned above. Once again, the size of the projections on the spherical body depicted in FIG. 15 is not to scale and should not be used as a representation of accurate proportions. The illustration of the projections is to show the movement of the spherical body during the demonstration and is not a depiction of actual distance traveled during the use of a rapid shallow movement. Using this technique a user travels approximately ½ inch along the soft tissue of the body per six staccato breath taken during exercise. The rapid (and shallow) pulse movement is used to quickly hydrate the shallow dried connective superficial tissue that are inhibiting the full range of motion and limiting use during movement activities. The rapid (and shallow) pulse is for the use of adding flexibility to the joints, thereby energizing muscle. Using rapid shallow pulses of pressure to re-mold the dry or bunched tissue is a myofascial technique with a focus on fascial tissue with some interaction with the surface of the muscle fibers. These results can vary on many factors including height, weight, activity level, flexibility, extremity length and many other anatomical, physical and mental disabilities.

b. Methods for Hemispherical Half Massage Tool

In another specific non-limiting embodiment, a hemispherical half can be used as a separate massage tool. The hemispherical half allows the user to treat the body bi-laterally simultaneously. Designed to be stable during use (magnet-side down), the hemispherical half has the largest base surface area of the any of the tools set in the multi-tool massage device and gives the user a firm grip on the floor or other flat surface. The hemispherical half can be used to perform mobility stretches with a focus on pin-and-stretch techniques. The hemispherical half also offers a unique application of AKT. An array of specifically designed projections, as discussed above, cover each hemispherical half. Each projection allows various layers of tissue to be broken up for different purposes, such as strength, pain relief and flexibility. Because of the stability of each hemispherical half coupled with the size of the individual projections, the user can place more heavy, deliberate and specific bodyweight and therefore increase the amount of pressure on the target area. The hemispherical half can also be used with a cloth such as, for example, a towel. This application lets the user place a larger amount of pressure on the muscle when performing specific pin-and-stretch techniques, i.e., supine active hamstring stretches. These techniques are ideal for individuals who have little to no movement restrictions, are generally not in pain, or who have a higher degree of range of motion. The hemispherical half utilizes single pin-and-stretch, pulse pin-and-stretch, AKT, slow pulse and rapid-short pulse techniques.

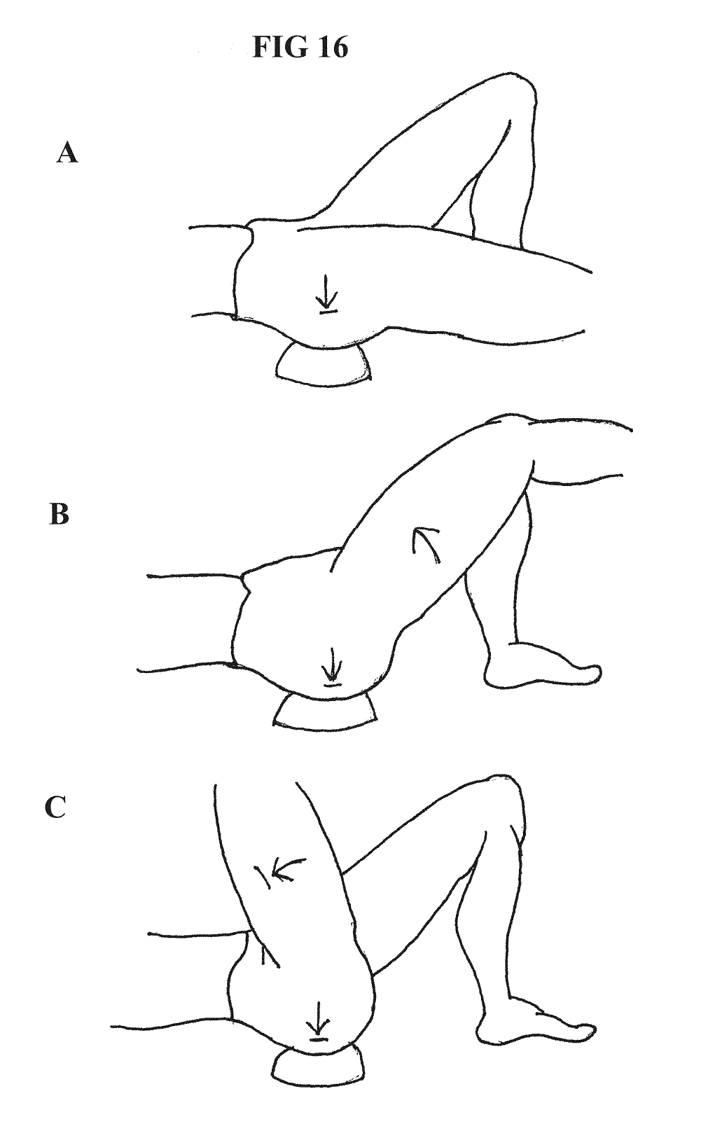

FIG. 16 illustrates one of the hemispherical halves being used for a pin-and-stretch technique, wherein the muscle is pressed against the hemispherical half to pinch the muscle between the same and the internal structures such as, for example, bones, muscles and the like. FIG. 16A illustrates the user in the start position with bodyweight pressure being applied to the hemispherical half. As the user breathes in, he/she pivots the upper leg at the hip joint (see FIG. 16B), resulting in the user's knee moving closer the user's chest. This movement also requires the user to maintain balance on the hemispherical half and the targeted area. FIG. 16C illustrates the completion of the movement. The method is commonly referred to as “active motion”. Using this technique, every movement made is intended for the user to do on his/her own instead of being worked by a therapist. All movements can be considered active motion while most of the movements are considered passive motion therapy or techniques.

c. Methods for the First Cylindrical Roller Massage Tool

In yet another specific non-limiting embodiment, the first cylindrical roller, which most closely represents a mini-foam roller or lacrosse ball, is designed to fit into small spaces of the body to directly affect deeper layers of muscle. With the projections on the first cylindrical roller, the user is able to feel where the tool is on the body without having to constantly reposition it. The first and second axial end ribs on the first cylindrical roller guide through the tissue while simultaneously being able to dig into the surrounding layers. This gives the user more control and helps soften the tissue around the target area. The medial rib mimics the knuckle while the first and second axial end ribs are used for targeted muscle stripping. They allow a user to target a smaller strip of muscle tissue with a larger amount of pressure. Because of the position of the first cylindrical roller, a user can place as little or as much pressure as desired as he/she moves across the target area. Muscle stripping is a technique that is used for quicker recovery and faster healing. When used correctly, it is very effective. Because of its aggressive nature, this technique is recommended for users that are comfortable with or are ready for a higher pain threshold. The hexagons and triangles surrounding the middle ridge are designed to catch, pinch and hold the surrounding tissues in place while deeper work is taking place. Because of the angles of each shape, there are many ways a user can utilize this tool to control the movement flow and angles of treatment. The option to “pin” a muscle against or directly “point” into a muscle gives the user the ability to direct how the muscle is attacked and manage the individual pain threshold. Because of the hollow center, the first cylindrical roller also acts as a “muscle stick roller” as well. By placing a cloth such as, for example, a towel or other object through the center circle, a user can apply pressure to the target muscle area and use this over the skin to break apart the superficial layers (fascia, connective tissue and muscle).

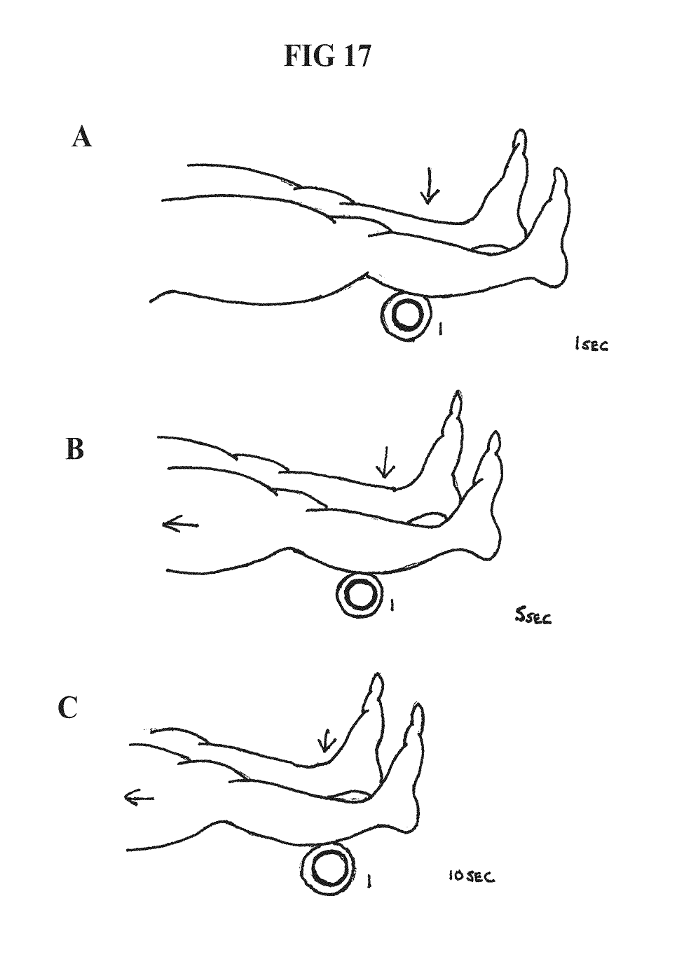

FIG. 17 illustrates using the first cylindrical roller. FIG. 17A illustrates a user applying the weight of the lower leg onto the surface of the first cylindrical roller. This pressure presses into the tissue approximately/2 inch. The user then slowly begins to pull back (see FIG. 17B) while maintaining the tissue depth from FIG. 17A, and FIG. 17C illustrates the completion of the movement shown in FIG. 17B after approximately 10 seconds. This is continued as a slow continuous pull until the entire length of muscle is treated. The tempo and depth are meant to be steady and deliberate. The surface area of the first cylindrical roller allows it to go deep enough into the human tissue to affect the deeper layers of the muscle, similar to that of a lacrosse ball, trigger point performance balls and other small massage designed balls currently available. This depth, if performed slowly, digs through the superficial tissue and reaches the deeper layer without causing the body to react with an involuntary muscle spasm.

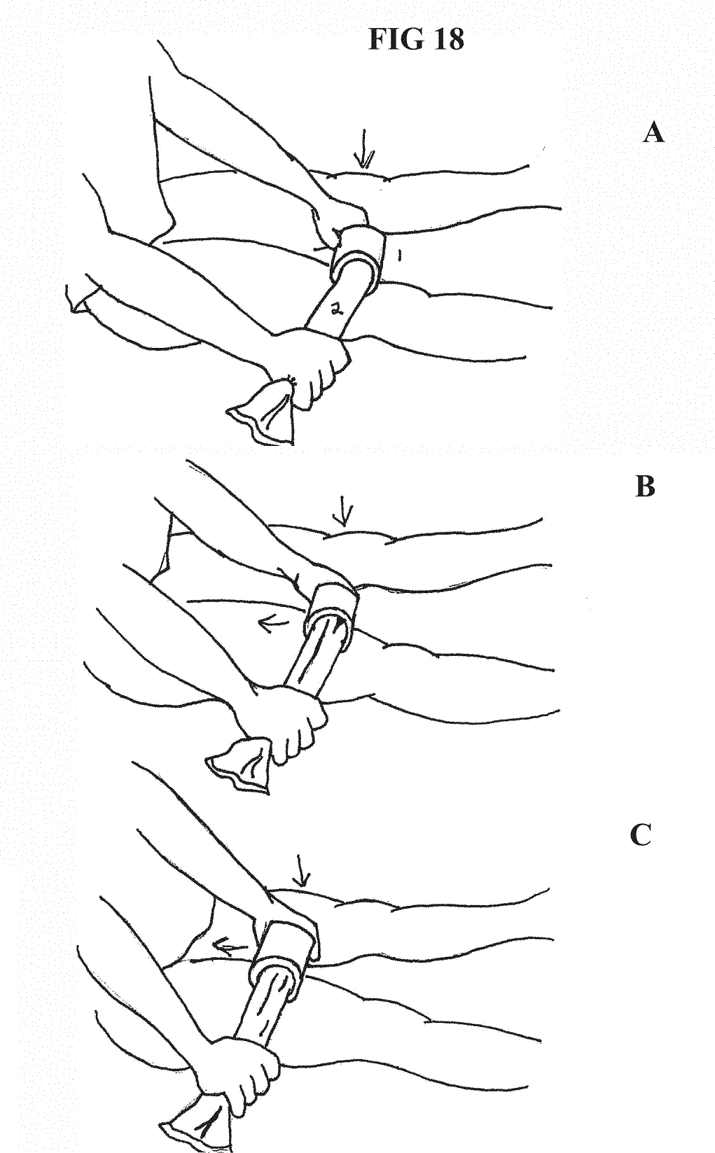

FIG. 18 illustrates the first cylindrical roller being used similar to a massage stick. Instead of a ridged stick of the user to hold onto, the first cylindrical roller has a piece of cloth such as, for example, a towel or other flexible fabrics that have the tensile strength to withhold the stress. FIG. 18A illustrates the user applying downward pressure onto the upper leg muscle just above the knee. This pressure presses into the tissue approximately ½ inch. The user then slowly begins to pull back (see FIG. 18B) while maintaining the tissue depth from FIG. 18A. This is continued as a slow continuous pull until the entire length of muscle is treated. FIG. 18C illustrates the completion of the movement shown in FIG. 18B. The tempo and depth are meant to be steady and deliberate. The use of the cloth during this movement allows the user more control of pressure and tempo.

d. Methods for the Second Cylindrical Roller Massage Tool

In still another specific non-limiting embodiment, the second cylindrical roller's main function is muscle shearing. Muscle shearing is a technique that is used for muscle and tendon repair. It consists of applied pressure followed by a twist or turning motion with the pressure. This action produces a turn and pull on the tissue while giving the user a sensation, resembling a friction burn. Each projection (hexagons, drops and chevrons) is positioned to cradle troubled areas such as knots during the twisting motion of muscle shearing. Because of the design layout, the user has a couple intensity options. Pinning the knot between the two chevron points (more aggressive) versus pinning the knot between the two triangles (less aggressive). Like the first cylindrical roller, the second cylindrical roller has first and second axial end ribs at both axial ends. These ribs are used to target ropey tendons and to relieve muscle and other deep tissue tension next to and under bones of the human body. The height of the first and second axial end ribs makes it easier for the user to safely angle the tool into position during treatment. This angle allows for a precise gliding compression along sensitive areas. Because of its cylindrical shape, the second cylindrical roller also has the ability to perform gliding compression or “rolling” for the forearms, hands, calves and feet.

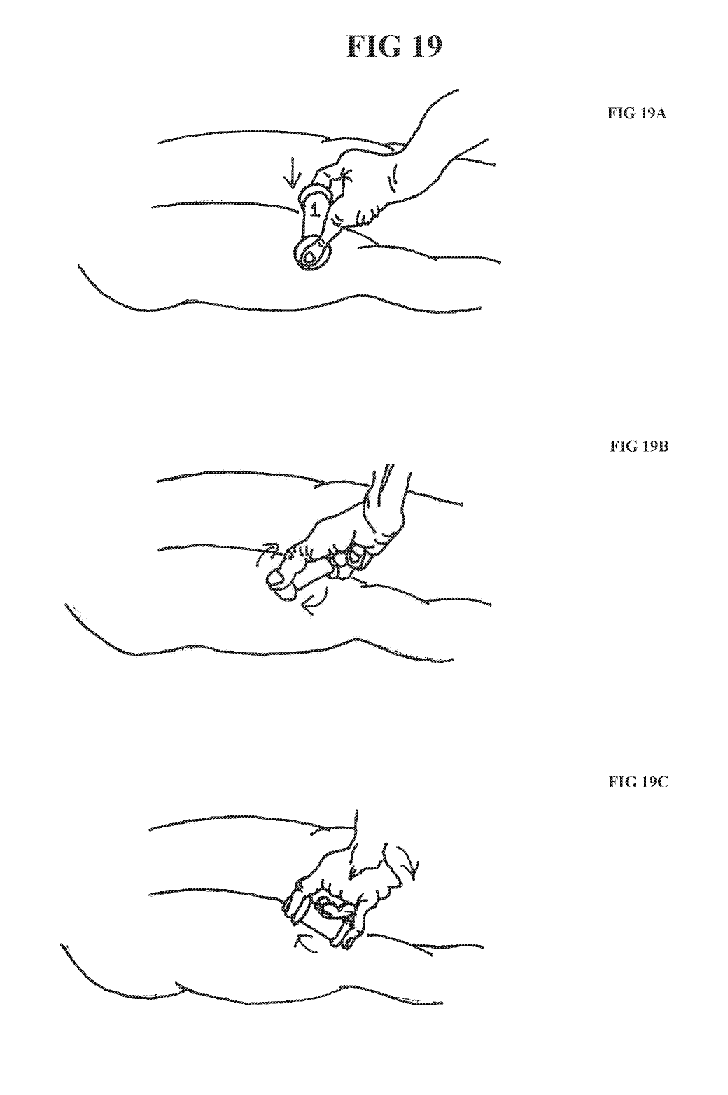

FIG. 19 illustrates using the second cylindrical roller. This tool is used for a muscle shearing action. FIG. 19A illustrates the user pressing the second cylindrical roller into the tissue of the upper leg. FIG. 19B illustrates the user maintaining the pressure shown in FIG. 19A while twisting the second cylindrical roller and causing a shearing or twisting micro tear of the superficial layers of connective tissue such as skin, fascia, muscles and tendon. As illustrated in FIG. 19C, the goal is to rotate the second cylindrical roller 90° while maintaining pressure and contact through the twist. The sensation given from this technique resembles that of a friction burn.

e. Methods for the End Cap Massage Tool

In yet another specific non-limiting embodiment, the end caps are used as massage tools, preferably as a hexagon as a projection on one end cap and a chevron as the projection on the other end cap. Both are pain relief tools designed to target small areas of tenderness and/or tightness. These tender points are typically knots that refer pain to other parts of the body when activated. The end cap with the hexagon projection offers the user a larger surface area for treatment and softer feel when applied. This makes it less aggressive for the user and much easier to control the movement of the knot or target tissue. The end cap with the chevron projection also treats small areas of tenderness and/or tightness but has a few extra points on it giving the user options for a more aggressive approach. Because of the point at the top, the user can cut into the knot with precision while the rounded point and curve of the chevron provide the user with a “catch” to cradle or pin the knot in place while treatment is taking place. Both the end cap with the hexagon projection and the end cap with the chevron projection are designed for circular pressure treatments. This treatment creates a pressured dotted circle around the knot to loosen the edges that are glued to the surrounding tissue. This technique takes the “pull” off of the knot before the user applies direct pressure on top of the knot itself. By doing this, the relief on the knot lasts longer because the surrounding tissue is less likely to pull on the area after the treatment is complete.

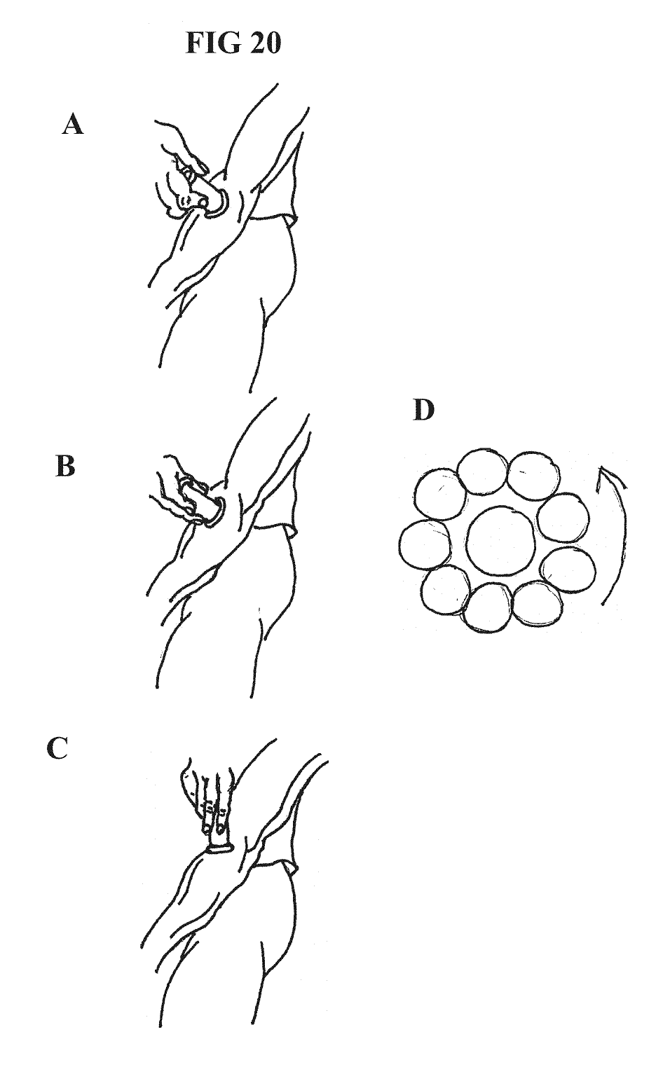

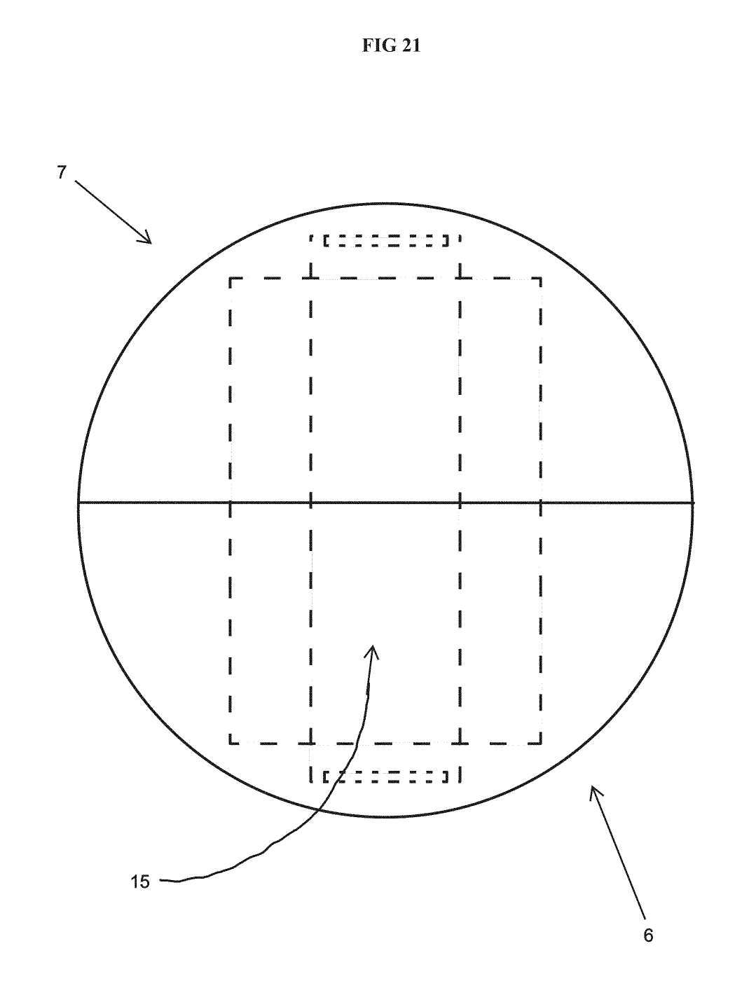

FIG. 20 illustrates using the end caps in a trigger point technique. FIG. 20A illustrates the user pressing into the tissue near a tender point or trigger point in the forearm muscle. This technique requires “drawing a dotted line of pressure around the target spot using a pulse movement (see FIG. 20B and FIG. 20D). This pulse movement keeps contact between the tissue and the end cap on the second cylindrical roller to increase pressure tolerances and allow the user to locate and control the tender spot of muscle. After the entire spot has been circled, the user then slides the end cap on the second cylindrical roller into the middle of the circle and presses to his/her own pain tolerance level for five seconds (see FIG. 20C). This is repeated three times to ensure the tender muscle has enough relief before returning to activity. Trigger point therapy is a very common practice but most trigger point theories require the use of sustained pressure to diffuse a trigger point flare up. This method of the instant invention warms the surrounding tissue to ease the surrounding pull and prepares the tender tissue for short but direct pressure.

In another non-limiting embodiment, the methods disclosed herein can be used in conjunction with a mobile application that teaches the user how to use each tool by offering how-to videos. The videos help users understand how and why self-care can affect the way the muscles are used and how the muscles work after applying pressure. The method can also optionally provide for integrated software which allows for variations controlled by the user, creating a vast number of muscle therapy routines.

What is claimed is:

1. A massage device comprising a spherical body comprising a first hemispherical half and a second hemispherical half that engage and disengage one another, the first hemispherical half and the second hemispherical half having a first outer shell and a second outer shell, respectively, and a first inner core and a second inner core, respectively;
the first outer shell and the second outer shell having a first outer surface and a second outer surface, respectively, the first outer surface and the second outer surface comprising a first plurality of one or more projections thereon, the first plurality of one or more projections, either alone or in combination, configured to mimic a body part, wherein the first outer surface and the second outer surface are symmetrical; and
the first inner core and the second inner core being substantially rigid and configured to include one or more individual and distinct massage tools held in a fixed position inside the spherical body when the first hemispherical half and the second hemispherical half are engaged.

2. The massage device of claim 1, wherein the first inner core and the second inner core extend medially from a first inner surface and a second inner surface of the first outer shell and the second outer shell, respectively, for a certain width to form a first inner core lip and a second inner core lip, wherein the first inner core and the second inner core define a spherical cavity when the first hemispherical half and the second hemispherical half are engaged to form the spherical body.

3. The massage device of claim 2, wherein the first hemispherical half and the second hemispherical half are engaged magnetically by magnets mounted in the first inner core lip and the second inner core lip.

4. The massage device of claim 3, wherein the first hemispherical half and the second hemispherical half are further engaged by an annular ridge formed on one of the first inner core lip or the second inner core lip projecting outwardly to fit within an annular groove on the other of the first inner core lip or the second inner core lip, the annular ridge and the annular groove positioned laterally to the magnets mounted in the first inner core lip and the second inner core lip.

5. The massage device according to claim 1, wherein the body part is selected from a group consisting of an elbow, a thumb, a knuckle, a palm or a combination thereof.

6. The massage device according to claim 2, wherein the one or more individual and distinct massage tools held in a fixed position inside the spherical body is a first cylindrical roller massage device comprising
a first cylindrical roller first axial end;
a first cylindrical roller second axial end;
an outer shell having an outer surface and an inner surface;
a first cylindrical roller core length extending between the first cylindrical roller first axial end and the first cylindrical roller second axial end;
an inner core secured to the inner surface of the outer shell and defining a hollow core interior extending throughout the first cylindrical roller core length, the hollow core interior having a hollow core interior diameter; and
wherein the first cylindrical roller first axial end is configured to rest against and fit into a first end of the spherical cavity and the first cylindrical roller first axial end is configured to rest against and fit into a second end of the spherical cavity such that the first cylindrical roller massage device is held in a first fixed position within the spherical cavity.

7. The massage device according to claim 6, wherein the first cylindrical roller massage device is rigid and the outer surface of the outer shell comprises a second plurality of one or more projections thereon, the second plurality of one or more projections, either alone or in combination, configured to mimic a body part.

8. The massage device according to claim 7, wherein a second cylindrical roller massage device is configured to slide into the hollow core interior of the first cylindrical roller massage device, the second cylindrical roller massage device having a total diameter substantially similar to the hollow core interior diameter of the first cylindrical roller massage device such that the second cylindrical roller massage device is held in a second fixed position within the spherical cavity.

9. The massage device according to claim 8, wherein the second cylindrical roller massage device is rigid and has a second cylindrical roller outer surface comprising a third plurality of one or more projections thereon, the third plurality of one or more projections, either alone or in combination, configured to mimic a body part.

10. The massage device according to claim 9, wherein the second cylindrical roller massage device has a second cylindrical roller first axial end and a second cylindrical roller second axial end, the second cylindrical roller first axial end comprising a first end cap thereon, and the second cylindrical roller second axial end comprising a second end cap thereon, each of the end caps having a same or different projection thereon configured to mimic a body part.

11. The massage device according to claim 1, wherein one of the first plurality of one or more projections is a rounded hexagon-shaped projection.

12. The massage device according to claim 11, wherein one of the first plurality of one or more projections is a rounded chevron-shaped projection.

13. The massage device according to claim 1, wherein one of the first plurality of one or more projections is a rounded triangle-shaped projection.

14. The massage device according to claim 7, wherein one of the second plurality of one or more projections is a rounded hexagon-shaped projection.

15. The massage device according to claim 14, wherein one of the second plurality of one or more projections is a rounded chevron-shaped projection.

16. The massage device according to claim 15, wherein one of the second plurality of one or more projections is a rounded triangle-shaped projection.

17. The massage device according to claim 9, wherein one of the third plurality of one or more projections is a rounded hexagon-shaped projection.

18. The massage device according to claim 17, wherein one of the third plurality of one or more projections is a rounded chevron-shaped projection.

19. The massage device according to claim 18, wherein one of the third plurality of one or more projections is a rounded triangle-shaped projection.

20. A method of providing an effective massage to an area of superficial and deep tissue of a human user, the area of superficial and deep tissue being in need of therapy, comprising the steps of a) simultaneously contacting a tool of claim 1 with both the area of superficial and deep tissue in need of therapy and a rigid surface; and b) moving the area of superficial and deep tissue in need of therapy over the tool of the invention while maintaining sufficient pressure between the tool and the area of superficial and deep tissue in need of therapy so as to roll the tool against both the rigid surface and the area of superficial and deep tissue in need of therapy, or press the tool against the area of superficial and deep tissue in need of therapy, for a time sufficient to administer the effective massage.
